(19) United States
(12) Patent Application Publication
(10) Pub. No.: US 2013/0273980 A1
(43) Pub. Date: Oct. 17, 2013

(54) SYSTEM AND METHOD FOR EXTENDING THE BATTERY LIFE OF A MOBILE DEVICE

(71) Applicants: Thomas P. VENTULETT, Atlanta, GA (US); Mary Elizabeth GORMAN, Atlanta, GA (US); Peter KENNARD, Brooklyn, NY (US); David PETCHEY, Mill Valley, CA (US); Brian TROXELL, Kennesaw, GA (US); Jonathan A. VENTULETT, Atlanta, GA (US)

(72) Inventors: Thomas P. VENTULETT, Atlanta, GA (US); Mary Elizabeth GORMAN, Atlanta, GA (US); Peter KENNARD, Brooklyn, NY (US); David PETCHEY, Mill Valley, CA (US); Brian TROXELL, Kennesaw, GA (US); Jonathan A. VENTULETT, Atlanta, GA (US)

(21) Appl. No.: 13/870,883

(22) Filed: Apr. 25, 2013

Related U.S. Application Data
(63) Continuation-in-part of application No. 12/633,349, filed on Dec. 8, 2009.
(60) Provisional application No. 61/201,445, filed on Dec. 8, 2008.

(51) Int. Cl. H04W 52/02

(52) U.S. Cl. CPC H04W 52/0209
USPC 455/574

(57) ABSTRACT

The present invention provides a system and method for extending the battery life of a mobile device. The method of extending the battery life of a mobile device can be broadly summarized by the following steps of determining if at least one component on the mobile device can be placed in a hibernation state for a predetermined time, setting a remote clock to a current time and powering off the at least one component on the mobile device that can be placed in the hibernation state. The method further includes waiting a predetermined interval selected by a user, wherein the time interval can be selected from a factory preset or an environmental setting, re-activating the at least one component on the mobile device that was placed in the hibernation state and synchronizing a system clock with the remote clock.

### CROSS-REFERENCE TO RELATED APPLICATIONS

This application claims the benefit of a continuation-in-part of U.S. patent application Ser. No. 12/633,349, filed on Dec. 8, 2009, entitled “SYSTEM AND METHOD FOR EXTENDING THE BATTERY LIFE OF A MOBILE DEVICE” having Patent Publication No. US 2010/0162021, and U.S. Provisional Patent Application 61/201,445, filed on Dec. 8, 2008, entitled “SYSTEM AND METHOD FOR EXTENDING THE BATTERY LIFE OF A MOBILE DEVICE”, all of which are entirely incorporated herein by reference.

### FIELD OF THE INVENTION

The present invention relates to the battery life of the mobile device, and more particularly, relates to a method and system for extending the battery life of a mobile device.

### BACKGROUND OF THE INVENTION

Typically, processors are used in a variety of applications, including portable computers devices, communication systems or GPS devices, use data processors that are capable of executing a variety of instructions. Especially with wireless and/or mobile communication devices (such as a cellular telephone, two-way radio, personal digital assistant (PDA), laptop computer, home entertainment equipment, etc.), the processor or processors in a device must be able to run various complex communication programs using only a limited amount of power that is provided by power supplies, such as batteries, contained within such devices.

For example, for a wireless communication device to participate in wireless communications, the device includes a built-in radio transceiver (i.e., receiver and transmitter) or is coupled to an associated radio transceiver (e.g., a station for in-home and/or in-building wireless communication networks, RF modem, etc.). To implement the transceiver function, a transmitter is provided which typically includes a data modulation stage, one or more intermediate frequency (IF) stages and a power amplifier. The data modulation stage converts raw data into baseband signals in accordance with a particular wireless communication standard. The intermediate frequency stages mix the baseband signals with one or more local oscillations to produce RF signals. The power amplifier amplifies the RF signals prior to transmission via an antenna.

In addition, one or more processors and other modules are used to form a receiver which is typically coupled to an antenna and includes a low noise amplifier, one or more intermediate frequency stages, a filtering stage and a data recovery stage. The low noise amplifier receives inbound RF signals via the antenna and amplifies them. The intermediate frequency stages mix the amplified RF signals with one or more local oscillations to convert the amplified RF signal into baseband signals or intermediate frequency signals. The filtering stage filters the baseband signals or the intermediate frequency (IF) signals to attenuate unwanted out-of-band signals to produce filtered signals. The data recovery stage recovers raw data from the filtered signals in accordance with the particular wireless communication standard.

Because of the computational intensity (and the associated power consumption by the processor(s)) for communications transceiver functions, it is an important goal in the design of wireless and/or mobile communication devices to minimize processor and other module operations (and the associated power consumption). It is particularly crucial for mobile applications in order to extend battery life.

In addition to the complexity of the computational requirements for a communications transceiver, such as described above, the ever-increasing need for higher speed communications systems imposes additional performance requirements and resulting costs for communications systems. In order to reduce costs, communications systems are increasingly implemented using Very Large Scale Integration (VLSI) techniques. The level of integration of communications systems is constantly increasing to take advantage of advances in integrated circuit manufacturing technology and the resulting cost reductions. This means that communications systems of higher and higher complexity are being implemented in a smaller and smaller number of integrated circuits.

Therefore, a need exists for a method and apparatus that provides reduced power consumption. Further limitations and disadvantages of conventional systems will become apparent to one of skill in the art after reviewing the remainder of the present application with reference to the drawings and detailed description which follows.

### SUMMARY OF THE INVENTION

The present invention provides a system and method for extending the battery life of a mobile device. In architecture, invention may be conceptualized as a system that includes a

An exemplary embodiment includes a method for extending the battery life of a mobile device. The method includes determining if at least one component on the mobile device can be placed in a hibernation state for a predetermined time, setting a remote clock to a current time and powering off the at least one component on the mobile device that can be placed in the hibernation state. The method further includes waiting a predetermined interval selected by a user, wherein the time interval can be selected from a factory preset or an environmental setting, re-activating the at least one component on the mobile device that was placed in the hibernation state and synchronizing a system clock with the remote clock.

Another exemplary embodiment includes a system for extending the battery life of a mobile device. Briefly described, in architecture, one embodiment of the system, among others, can be implemented as follows. The system includes a priority determination module that determines if at least one component on the mobile device can be placed in a hibernation state for a predetermined time selected by a user, wherein the time interval can be selected from a factory preset or an environmental setting, and a remote clock that is set to a current time of a system clock. The system further includes a deactivate module that powers off the at least one component on the mobile device that can be placed in the hibernation state, and an interrupt routine that reactivates the at least one component on the mobile device that was placed in the hibernation state after waiting a predetermined interval and synchronizes the system clock with the remote clock.

A further exemplary embodiment includes a computer program product for extending the battery life of a mobile device. The computer program product including a tangible storage medium readable by the mobile device and storing instructions or execution by the mobile device for performing a method. The method includes determining if at least one component on the mobile device can be placed in a hibernation state for a predetermined time, setting a remote clock to the current time, and powering off the at least one component on the mobile device that can be placed in the hibernation state. The method further includes waiting a predetermined interval selected by a user, wherein the predetermined time can be selected from a factory preset or an environmental setting, re-activating the at least one component on the mobile device that was placed in the hibernation state, and synchronizing a system clock with the remote clock.

These and other aspects, features and advantages of the invention will be understood with reference to the drawing figure and detailed description herein, and will be realized by means of the various elements and combinations particularly pointed out in the appended claims. It is to be understood that both the foregoing general description and the following brief description of the drawing and detailed description of the invention are exemplary and explanatory of preferred embodiments of the invention, and are not restrictive of the invention, as claimed.

### BRIEF DESCRIPTION OF THE DRAWINGS

The present invention, as defined in the claims, can be better understood with reference to the following drawings. The components within the drawings are not necessarily to scale relative to each other, emphasis instead being placed upon clearly illustrating the principles of the present invention.

FIG. 1 is a block diagram illustrating an example of an environment of computer systems and the remote devices utilizing the exemplarily GPS tracking system with the battery extension system of the present invention.

FIG. 2A is a block diagram illustrating an example of a server utilizing the exemplarily GPS tracking system, as shown in FIG. 1.

FIG. 2B is a block diagram illustrating an example of a remote device utilizing the exemplarily GPS tracking system with the battery extension system of the present invention, as shown in FIG. 1.

FIG. 3A is a flow chart illustrating an example of the operation of the communication system with the exemplarily GPS tracking system on the server, as shown in FIGS. 1 and 2A.

FIG. 3B is a flow chart illustrating an example of the operation of the remote device system with the exemplarily GPS tracking system with the battery extension system of the present invention on the remote device, as shown in FIGS. 1 and 2B.

FIG. 4A is a flow chart illustrating an example of the operation of the exemplarily GPS tracking system on the server, as shown in FIGS. 1-3.

FIG. 4B is a flow chart illustrating an example of the operation of the remote device tracking system utilized by the exemplarily GPS tracking system with the battery extension system of the present invention, as shown in FIGS. 1-3.

FIG. 5A is a flow chart illustrating an example of the operation of the configuration process utilized by the exemplarily GPS tracking system of the present invention, as shown in FIGS. 2A-4A.

FIG. 5B is a flow chart illustrating an example of the operation of the configuration agent utilized on the remote device for the exemplarily GPS tracking system with the battery extension system, as shown in FIGS. 2A-4B.

FIG. 6A is a flow chart illustrating an example of the operation of the emergency process utilized by the exemplarily GPS tracking system of the present invention, as shown in FIGS. 2A-5A.

FIG. 6B is a flow chart illustrating an example of the operation of the emergency agent utilized on the remote device for the exemplarily GPS tracking system with the battery extension system of the present invention, as shown in FIGS. 2A-5B.

FIG. 7A is a flow chart illustrating an example of the operation of the tracking process utilized by the exemplarily GPS tracking system of the present invention, as shown in FIGS. 2A-6A.

FIG. 7B is a flow chart illustrating an example of the operation of the tracking agent utilized on the remote device for the exemplarily GPS tracking system with the battery extension system of the present invention, as shown in FIGS. 2A-6B.

FIG. 8A is a flow chart illustrating an example of the operation of the negotiate communication link process utilized by the exemplarily GPS tracking system of the present invention, as shown in FIGS. 2A-7A.

FIG. 8B is a flow chart illustrating an example of the operation of the negotiate communication link agent utilized on the remote device for the exemplarily GPS tracking system with the battery extension system of the present invention, as shown in FIGS. 2A-7B.

FIG. 9 is a flow chart illustrating an example of the operation of the flashlight agent utilized on the remote device for the exemplarily GPS tracking system of the present invention, as shown in FIGS. 2A-8B.

FIG. 10A is a flow chart illustrating an example of the operation of the GPS agent utilized on the remote device for the exemplarily GPS tracking system with the battery extension system of the present invention, as shown in FIG. 7B.

FIG. 10B is a flow chart illustrating an example of the operation of the sleep agent utilized on the remote device for the exemplarily GPS tracking system with the battery extension system of the present invention, as shown in FIGS. 4B and 10A.

### DETAILED DESCRIPTION OF THE INVENTION

The invention to be described hereafter is applicable to all remote devices using a battery extension system in the present invention. While described below with respect to an exemplar GPS tracking system, the battery extension system of the present invention can be utilized on any mobile device, such as for example but not limited to, mobile PCs, laptops, PDAs, pocket PCs, pagers, cellular phones, palm devices, tablet PCs, e-book display devices and any portable computing device.

The exemplar GPS tracking system provides the following benefits: (1) integrated with remote devices such as GPS enabled cell phones; (2) remote system settings controls and management; and (3) remote configuration of simultaneous voice and data communications; (4) emergency communications priority message handling, and (5) battery extension system of the present invention.

Mobile professionals will carry multiple mobile computing devices all of which have specific usage and connection characteristics, making each device uniquely appropriate for certain mobile usage situations. Given the diversity of devices an obvious user problem is, short battery life. The present invention is a battery extension system and the purpose of such power management is to achieve the highest efficiency of operation without the limitation of performance for mission critical/important operations.

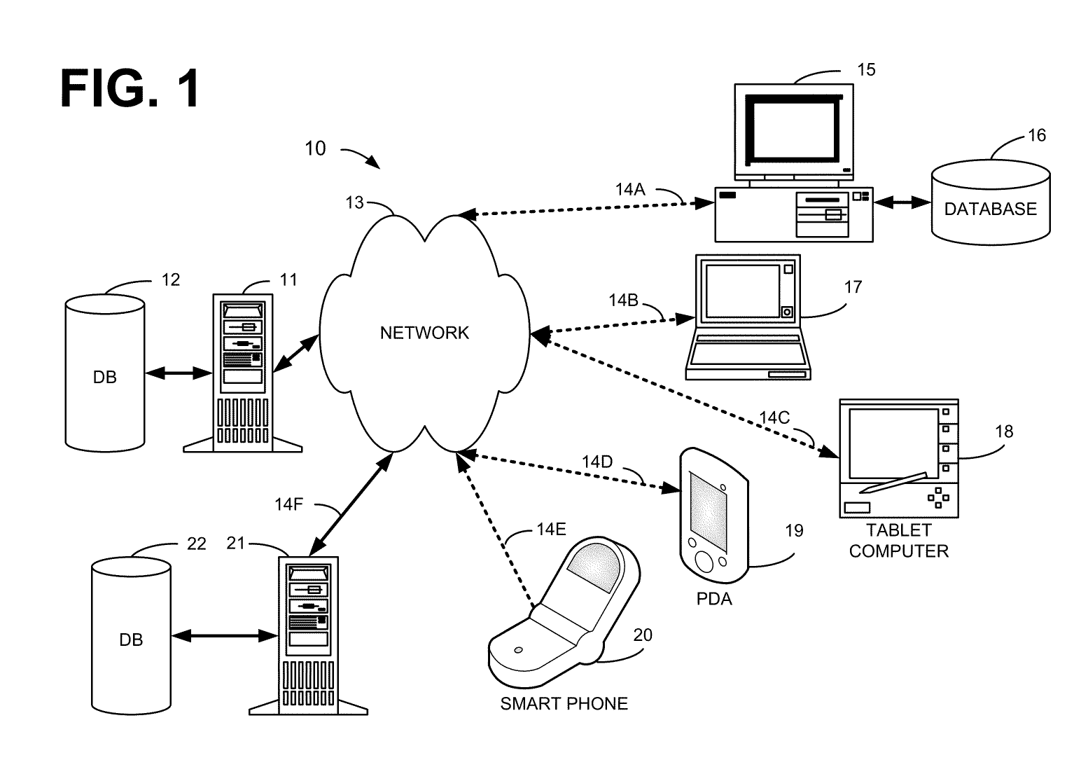

Referring now to the drawings, in which like numerals illustrate like elements throughout the several views, FIG. 1 is a block diagram illustrating an example of a exemplarily GPS tracking system 10 environment including computer servers (11 and 21) and the remote devices (15, 17, 18, 19 and 20) that utilize the battery extension system of the present invention.

Each remote device 15 and 17-20 has applications and can have a local data store 16. Computer servers 11 and 21 contain applications and server 11 further contains a server database 12 that is accessed by remote devices 15, and 17-20 via intermittent connections 14(A-F), respectively, over network 13. The server 11 runs administrative software for a computer network and controls access to part or all of the network and its devices. The remote devices 15 and 17-20 share the server data stored on the database 12 and may access the server 11 over a network 13 such as but not limited to; the Internet, a local area network (LAN), a wide area network (WAN), via a telephone line using a modem or other like networks. The server 11 may also be connected to the local area network (LAN) within an organization.

The structure and operation of the remote GPS tracking system enables the server 11 and the database 12 associated therewith to handle clients more efficiently than previously known systems. Particularly, the remote GPS tracking system of the present invention provides a manner of providing tracking of mobile devices over a network. When the remote devices 15 and 17-20 (FIG. 1) connect to the server 11, the identity and IP address information associated with the remote devices 15 and 17-20 are transmitted to the server to be used for delivering data to the remote device.

The remote devices 15 and 17-20 may each be located at remote sites. Remote devices 15 and 17-20 include but are not limited to; PCs, workstations, laptops, PDAs, pocket PCs, pagers, cellular phones, satellite phones, tablet PCs, e-book display devices, palm devices and the like. Mobile devices include any of the described remote devices and any electrical device that runs on batteries. Thus, when a user at one of the remote devices 15 and 17-20 desires to update the current tracking information on the data at the server 11, the remote devices 15 and 17-20 communicates over the network 13, such as but not limited to WAN, internet, or telephone lines to access the server 11. Hereafter, all remote devices will be referred to as remote device 15 for the sake of brevity.

The exemplar GPS system and method for notifying a remote device 15 that there is GPS data ready for transfer from server 11. First, a remote device 15 registers with server 11 to tell them that a remote device is ready to receive data. Periodically, the server 11 determines if new data is available for a remote device 15 or 17-20. When a remote device 15 or 17-20 connects to the server 11, the remote device 15 or 17-20 downloads that data from the server 11.

Third party servers 21 and databases 22 can be accessed by the server 11 in order to obtain information for dissemination to the remote devices 15 and 17-20. Information regarding the GPS position of the remote device, or tracking an emergency situation using a remote device. Data that is obtained from third party server 21 and databases 22 can be stored on the server 11 in order to provide later access to the remote device 15 and 17-20. It is also contemplated that for certain types of data that the remote device 15 or 17-20 can access the third-party vendor's data directly using the network 13.

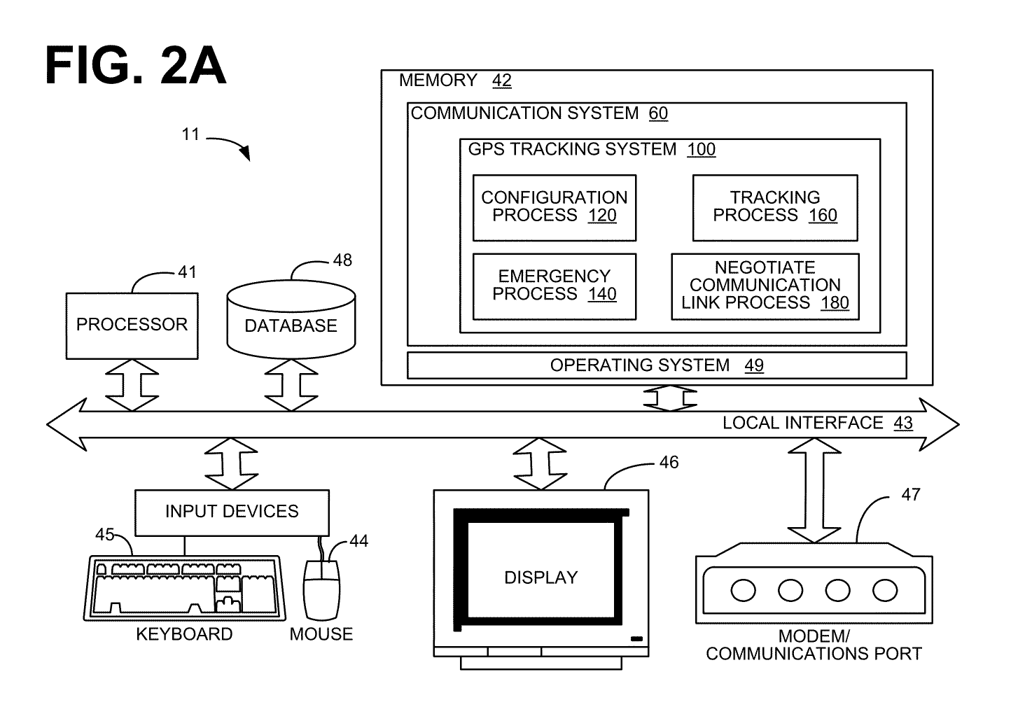

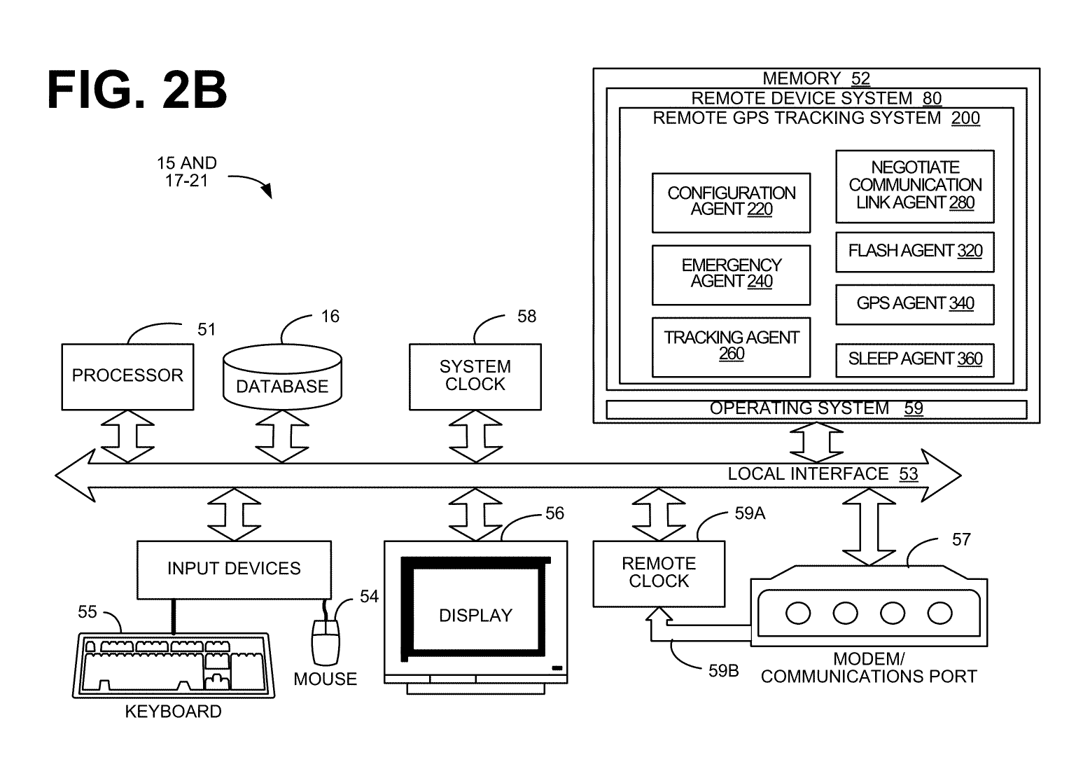

Illustrated in FIG. 2A is a block diagram demonstrating an example of a server 11, as shown in FIG. 1, utilizing the Exemplar GPS tracking system 100. Illustrated in FIG. 2B is an example demonstrating remote device 15 or 17-20 utilizing the remote portion of the remote device GPS tracking system 200 of the present invention. Remote devices 15 and 17-20 include, but are not limited to, PCs, workstations, laptops, PDAs, pagers, WAP devices, non-WAP devices, Pocket PCs, tablet PCs, e-book display devices, cellular, and satellite phones, palm devices and the like. The components of the remote device 15 and 17-20 are substantially similar to that of the description for the server 11 (FIG. 2A). However, it is contemplated that many of the components in the remote device 15 and 17-20 can be more limited in general function.

Generally, in terms of hardware architecture, as shown in FIG. 2A, the computer servers 11 and 21 herein includes a processor 41, memory 42, and one or more input and/or output (I/O) devices (or peripherals), such as database or storage 48, that are communicatively coupled via a local interface 43. The local interface 43 can be, for example but not limited to, one or more buses or other wired or wireless connections, as is known in the art. The local interface 43 may have additional elements, which are omitted for simplicity, such as controllers, buffers (caches), drivers, repeaters, and receivers, to enable communications. Further, the local interface 43 may include address, control, and/or data connections to enable appropriate communications among the aforementioned components.

The processor 41 is a hardware device for executing software that can be stored in memory 42. The processor 41 can be virtually any custom made or commercially available processor, a central processing unit (CPU) or an auxiliary processor among several processors associated with the computer servers 11 and 21, and a semiconductor based microprocessor (in the form of a microchip) or a macroprocessor. Examples of some suitable commercially available microprocessors include, but are not limited to: an 80x86, Pentium, Celeron, Xeon or Itanium series microprocessor from Intel Corporation, U.S.A., a PowerPC microprocessor from IBM, U.S.A., a Sparc microprocessor from Sun Microsystems, Inc, a PA-RISC series microprocessor from Hewlett-Packard Company, U.S.A., or a 68xxx series microprocessor from Motorola Corporation, U.S.A.

The memory 42 can include any one or combination of volatile memory elements (e.g., random access memory (RAM, such as dynamic random access memory (DRAM), static random access memory (SRAM), etc.)) and nonvolatile memory elements (e.g., read only memory (ROM), erasable programmable read only memory (EPROM), electronically erasable programmable read only memory (EEPROM), programmable read only memory (PROM), tape, compact disc (CD-ROM), DVD read on memory, magnetic disk, diskette, cartridge, cassette or the like, etc.). Moreover, the memory 42 may incorporate electronic, magnetic, optical, and/or other types of storage media. Note that the memory 42 can have a distributed architecture where various components are situated remote from one another, but still can be accessed by processor 41.

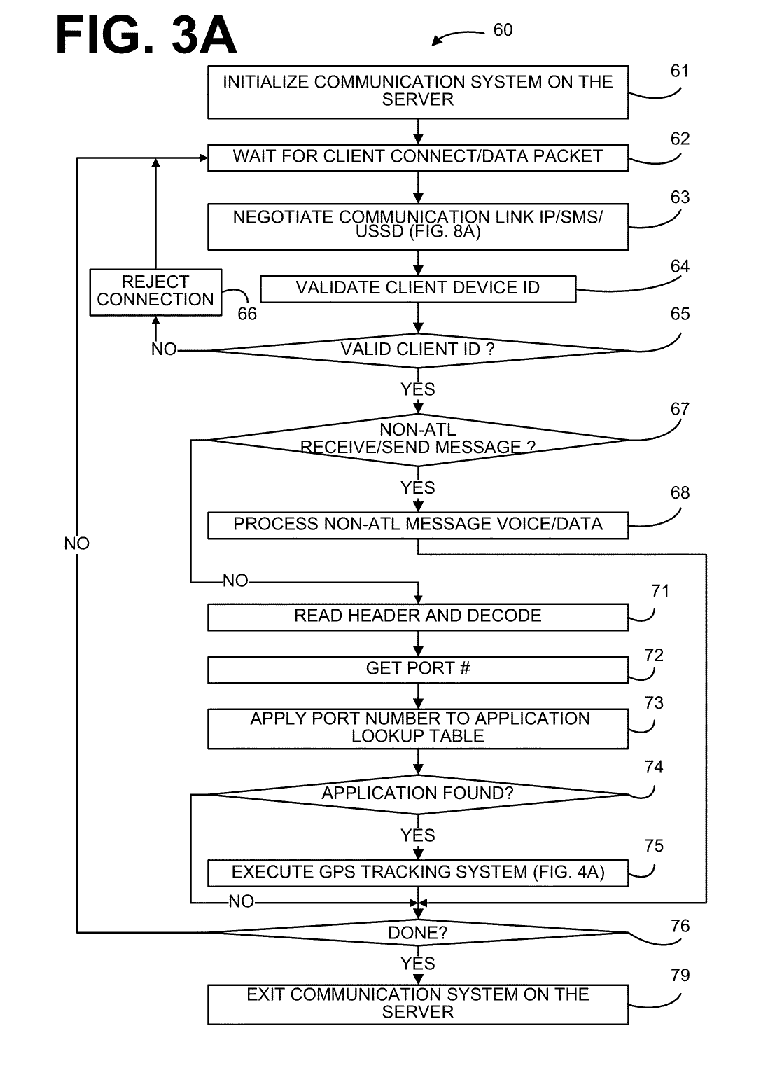

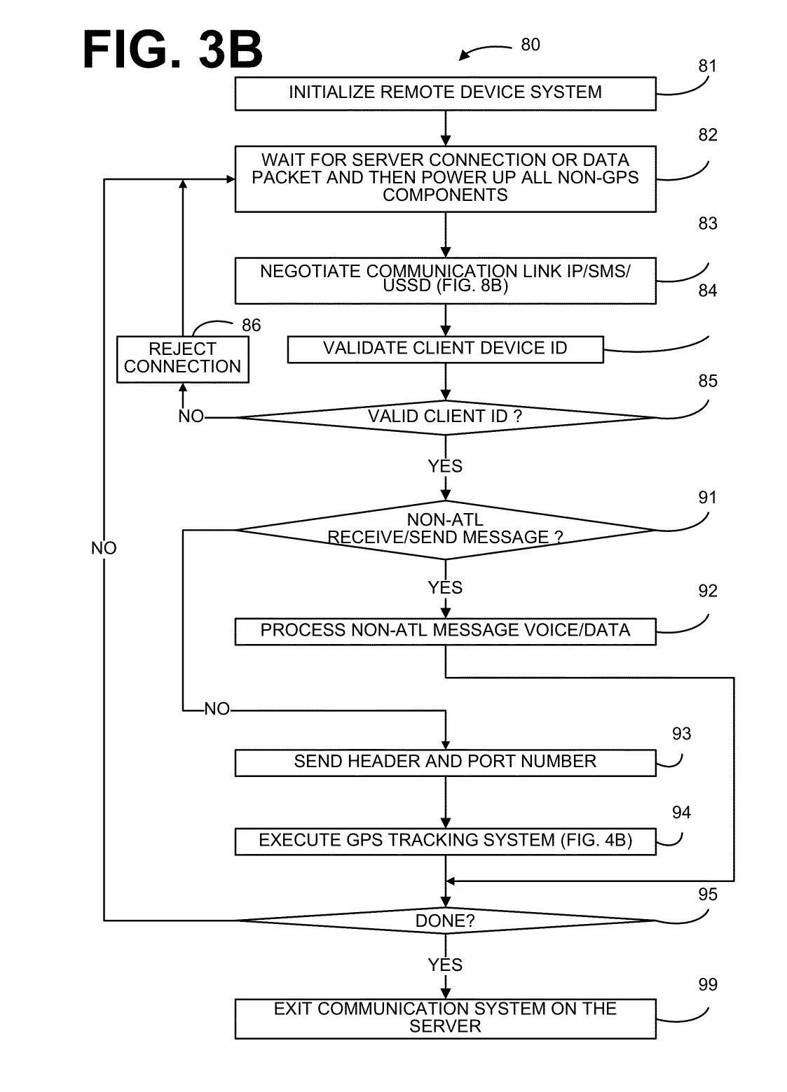

The software in memory 42 may include one or more separate programs, each of which comprises an ordered listing of executable instructions for implementing logical functions. In the example illustrated in FIG. 2A, the software in the memory 42 includes, but is not limited to, a suitable operating system (0/S) 49 and the exemplar GPS tracking system 100. The GPS tracking system 100 further includes the configuration process 120, emergency process 140, tracking process 160 and negotiate communication link process 180. The software components will be described in further detail with regard to FIG. 3A through FIG. 9.

A nonexhaustive list of examples of suitable commercially available operating systems 49 is as follows: (a) a Windows operating system available from Microsoft Corporation; (b) a Netware operating system available from Novell, Inc.; (c) a Macintosh operating system available from Apple Computer, Inc.; (e) a UNIX operating system, which is available for purchase from many vendors, such as the Hewlett-Packard Company, Sun Microsystems, Inc., and AT&T Corporation; (d) a LINUX operating system, which is freeware that is readily available on the Internet; (e) a run time Vxworks operating system from WindRiver Systems, Inc.; or (f) an appliance-based operating system, such as that implemented in handheld computers or personal data assistants (PDAs) (e.g., Symbian OS available from Symbian, Inc., Palm OS available from Palm Computing, Inc., and Windows Mobile available from Microsoft Corporation).

The operating system 49 essentially controls the execution of other computer programs, such as the exemplar GPS tracking system 100, and provides scheduling, input-output control, file and data management, memory management, and communication control and related services. However, it is contemplated by the inventors that the exemplar GPS tracking system 100 is applicable on all other commercially available operating systems.

The GPS tracking system 100 may be a source program, executable program (object code), script, or any other entity comprising a set of instructions to be performed. When a source program, then the program is usually translated via a compiler, assembler, interpreter, or the like, which may or may not be included within the memory 42, so as to operate properly in connection with the 0/S 49. Furthermore, the GPS tracking system 100 can be written as (a) an object oriented programming language, which has classes of data and methods, or (b) a procedure programming language, which has routines, subroutines, and/or functions, for example but not limited to, C, C++, Pascal, BASIC, FORTRAN, COBOL, Perl, Java, ADA and the like.

The I/O devices may include input devices, for example but not limited to, a keyboard 45, mouse 44, scanner (not shown), microphone (not shown), etc. Furthermore, the I/O devices may also include output devices, for example but not limited to, a printer (not shown), display 46, etc. Finally, the I/O devices may further include devices that communicate both inputs and outputs, for instance but not limited to, a NIC or modulator/demodulator 47 (for accessing other files, devices, systems, or a network), a radio frequency (RF) or other transceiver (not shown), a telephonic interface (not shown), a bridge (not shown), a router (not shown), etc.

If the computer servers 11 and 21 are a PC, workstation, intelligent device or the like, the software in the memory 42 may further include a basic input output system (BIOS) (omitted for simplicity). The BIOS is a set of essential software routines that initialize and test hardware at startup, start the O/S 49, and support the transfer of data among the hardware devices. The BIOS is stored in some type of read-only-memory, such as ROM, PROM, EPROM EEPROM or the like, so that the BIOS can be executed when the computer is activated.

When the computer servers 11 and 21 are in operation, the processor 41 is configured to execute software stored within the memory 42, to communicate data to and from the memory 42, and to generally control operations of the computer pursuant to the software. The GPS tracking system 100 and the 0/S 49 are read, in whole or in part, by the processor 41, perhaps buffered within the processor 41, and then executed.

When the exemplar GPS tracking system 100 is implemented in software, as is shown in FIGS. 2A and 2B, it should be noted that the GPS tracking system 100 can be stored on virtually any computer readable medium for use by or in connection with any computer related system or method. In the context of this document, a computer readable medium is an electronic, magnetic, optical, or other physical device or means that can contain or store a computer program for use by or in connection with a computer related system or method. The GPS tracking system 100 can be embodied in any computer-readable medium for use by or in connection with an instruction execution system, apparatus, or device, such as a computer-based system, processor-containing system, or other system that can fetch the instructions from the instruction execution system, apparatus, or device and execute the instructions.

In the context of this document, a “computer-readable medium” can be any means that can store, communicate, propagate, or transport the program for use by or in connection with the instruction execution system, apparatus, or device. The computer readable medium can be, for example but not limited to, an electronic, magnetic, optical, electromagnetic, infrared, or semiconductor system, apparatus, device, or propagation medium. More specific examples (a nonexhaustive list) of the computer-readable medium would include the following: an electrical connection (electronic) having one or more wires, a portable computer diskette (magnetic), a random access memory (RAM) (electronic), a read-only memory (ROM) (electronic), an erasable programmable read-only memory (EPROM, EEPROM, or Flash memory) (electronic), an optical fiber (optical), and a portable compact disc read-only memory (CDROM) (optical). Note that the computer-readable medium could even be paper or another suitable medium upon which the program is printed, as the program can be electronically captured, via for instance optical scanning of the paper or other medium, then compiled, interpreted or otherwise processed in a suitable manner if necessary, and then stored in a computer memory.

In an alternative embodiment, where the GPS tracking system 100 is implemented in hardware, the GPS tracking system 100 can be implemented with any one or a combination of the following technologies, which are each well known in the art: a discrete logic circuit(s) having logic gates for implementing logic functions upon data signals, an application specific integrated circuit (ASIC) having appropriate combinational logic gates, a programmable gate array(s) (PGA), a field programmable gate array (FPGA), etc.

Illustrated in FIG. 2B is a block diagram demonstrating an example of a remote device 15 and 17-20 and third party servers 21 utilizing the remote device GPS tracking system 200 of the present invention, as shown in FIG. 1. As illustrated, the remote device 15 and 17-20 includes many of the same components as server 11 described with regard to FIG. 2A. Hereinafter, the remote devices 15 and 17-20 will be referred to as remote device 15 for the sake of brevity.

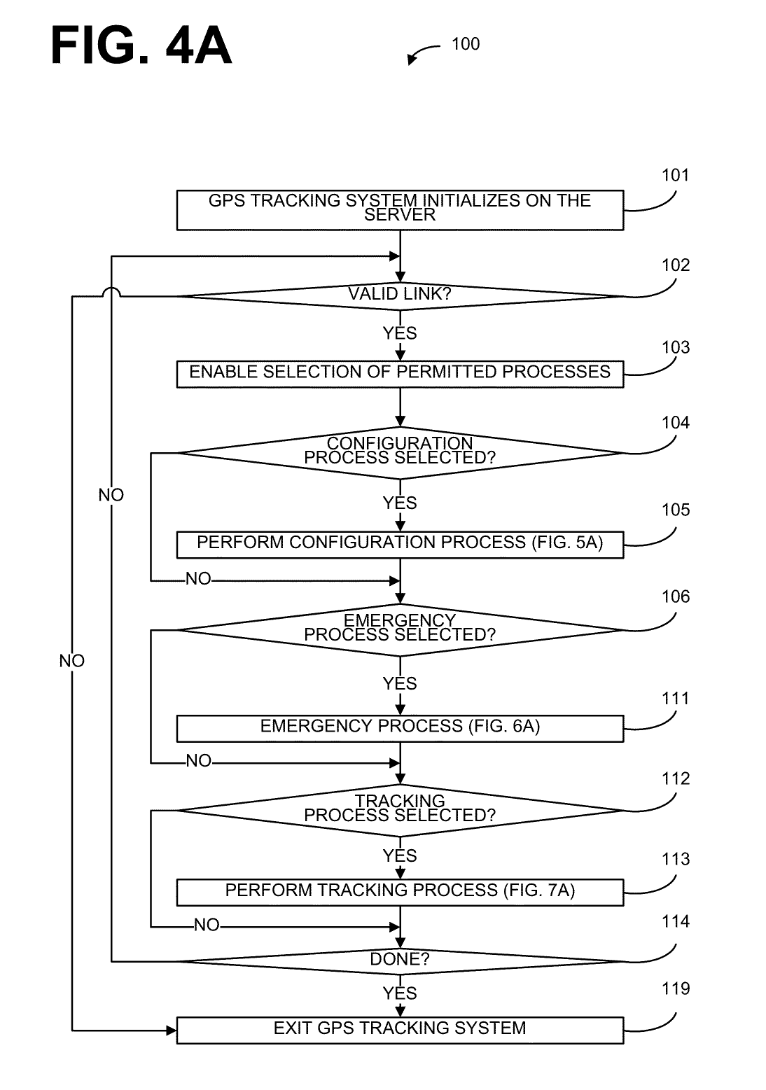

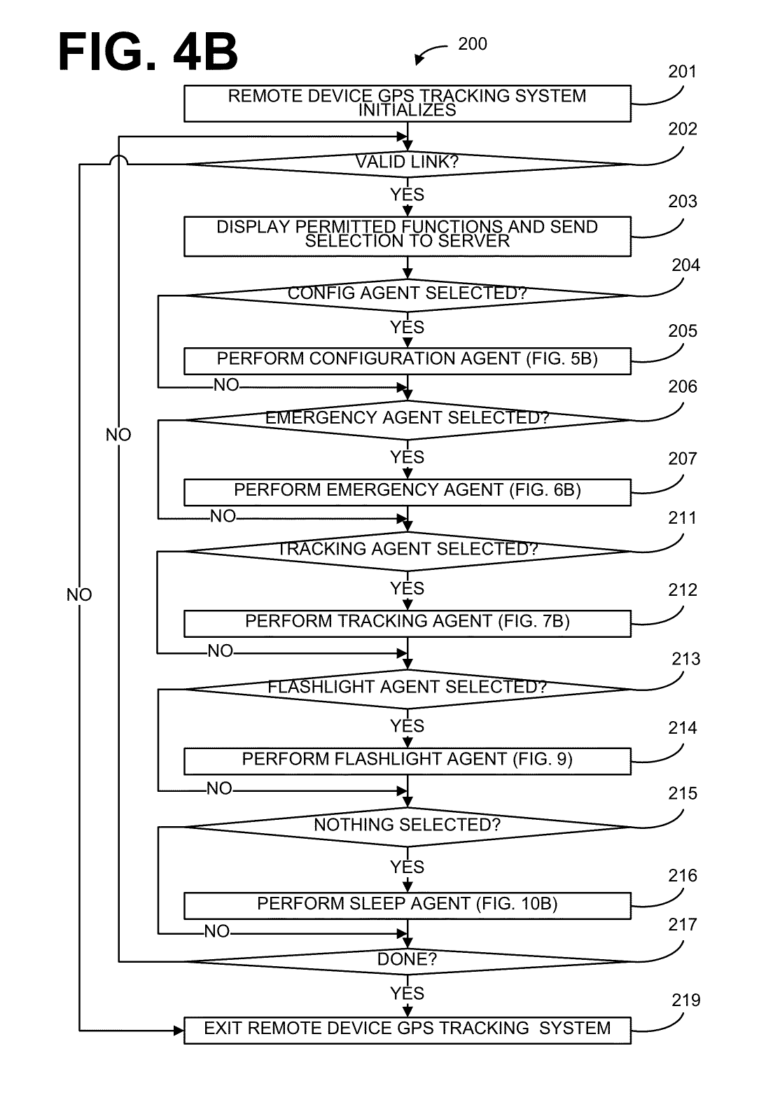

Located in memory 52 is the remote device system 80, which includes, but is not limited to, the remote device GPS tracking system 200. Located in memory 52 is the remote device system 80, which includes, but is not limited to, the remote device GPS tracking system 200. The remote device GPS tracking system 200 further includes the configuration agent to 220, emergency agent 240, tracking agent 260, negotiate communication link agent 280, flashlight agent 320, GPS agent 340 and sleep agent 360 of the present invention. The remote device GPS tracking system 200 and sub-components are herein defined in further detail with regard to FIG. 4B through FIG. 10B. When the remote device GPS tracking system 200 is implemented in software, as is shown in FIG. 2B, it can be stored on virtually any computer readable medium for use by or in connection with any computer related system or method.

In an alternative embodiment, where the remote device system 80 is implemented in hardware, the remote device GPS tracking system 200 can be implemented in the same way as described above with regard to the GPS tracking system 100 (FIG. 2A). In the example illustrated, it is the remote device GPS tracking system 200 that interacts with the exemplar GPS tracking system 100.

FIG. 3A is a flow chart illustrating an example of the operation of the communication system 60 with the exemplar GPS tracking system 100 on the server 11, as shown in FIGS. 1 and 2A. The communication system 60 negotiates the communication link to use between the server 11 and a remote device 15 and determines if the message is a standard voice data message or an Airo Wireless telematics logic message.

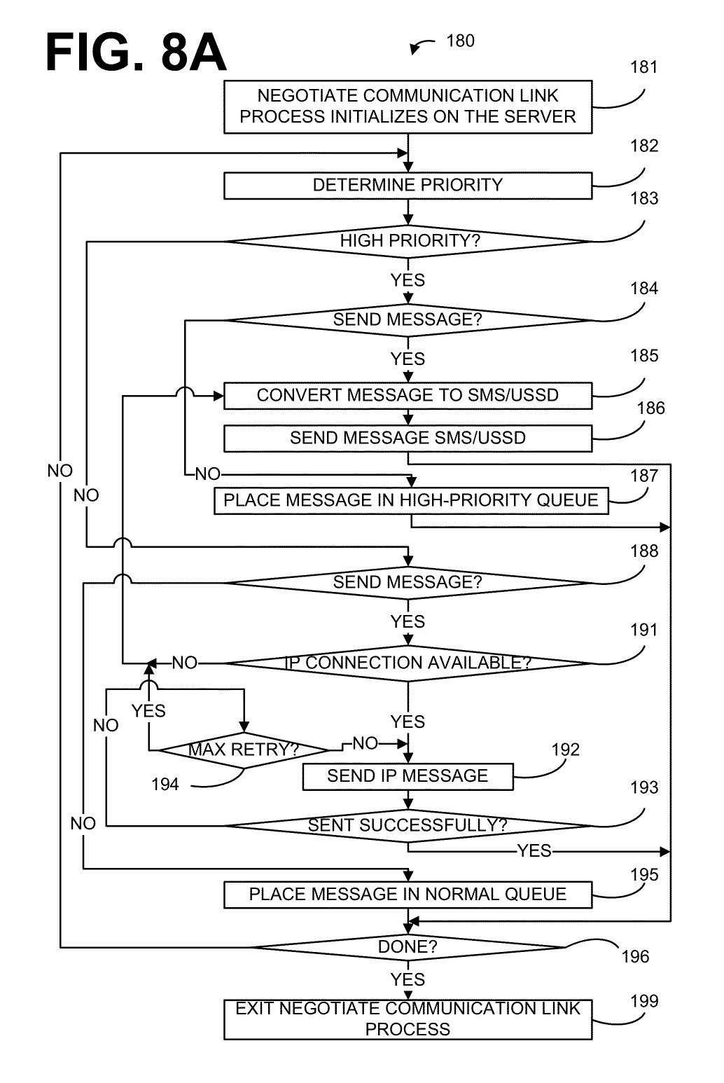

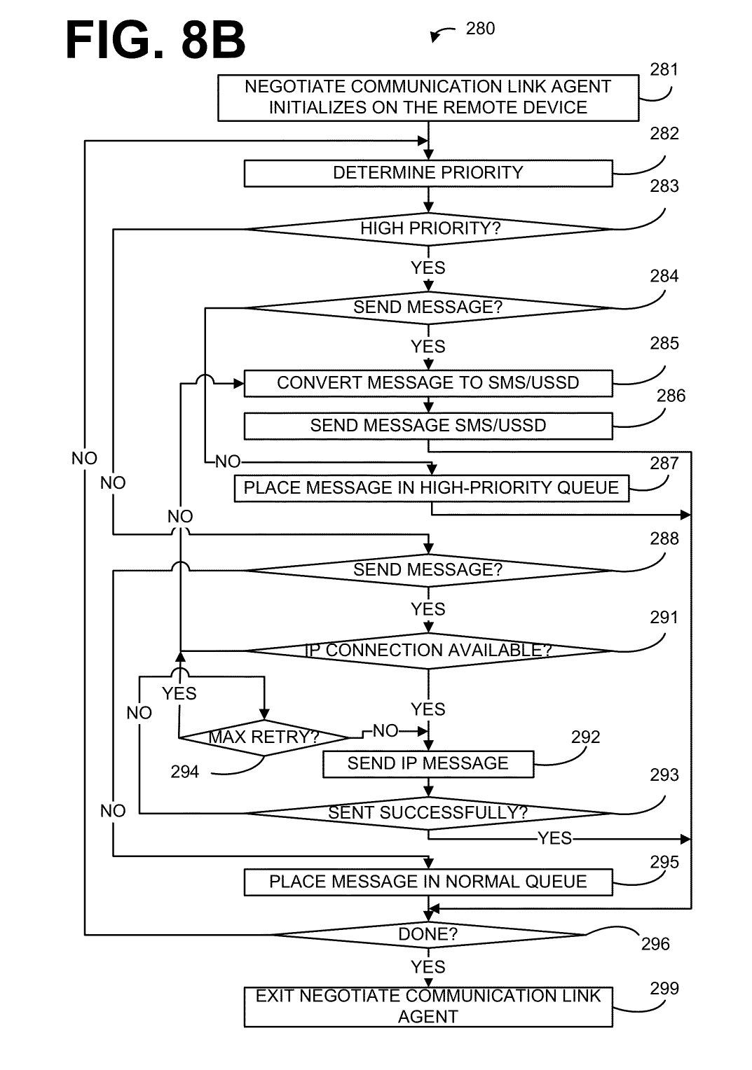

First at step 61, the communication system 60 is initialized. This initialization includes the startup routines and processes embedded in the BIOS of the server 11. The initialization also includes the establishment of data values for particular data structures utilized in the server 11 and communication system 60. At step 62, the communication system 60 waits for a client connect or data packet. Upon acquiring or sending a data packet, the communication system 60 negotiates the communication link speed. In one embodiment this connection occurs on a predetermined port. However, it is understood that other types of connections may be utilized. At step 63, the negotiate communications link process is herein defined in further detail with regard to FIG. 8A.

The communication system 60 then validates the client device ID at step 64. At step 65, it is determined if the client ID for the client connect or data packet is valid. If it is determined at step 65 that the client ID for the communication sent or received is invalid, the communication system 60 then rejects the connection in step 66 and returns to wait for the next connection at step 62.

However, if it is determined at step 65 that the client ID is valid, then the communication system 60 determines if the communication is a standard send and receive message at step 67. If it is determined that step 67 that the message is a standard send or receive message, then the message is processed at step 68, utilizing the current voice and data processing as currently available in the art.

However, it is determined to step 67 that the message received is not a standard message (i.e., an Airo Wireless Telematics Logic message), then the communication system 60 reads the header in the message and decodes in step 71. At step 72 the communication system 60 gets the port number from the message and looks up the application associated with that port in step 73.

At step 74, the communication system 60 determines if an application was found utilizing the port number. If it is determined at step 74 that an application corresponding to the port number is not found, in the communication system 60 skips to step 76. However, if it is determined at step 74 that an application corresponding to the port number received in the message was found, then the communication system 60 executes the GPS tracking system at step 75. The GPS tracking system is herein defined in further detail with regard to FIG. 4A.

At step 76, it is determined if there are more messages to be processed. If it is determined at step 76 that there are more messages to be processed, then the communication system 60 returns to repeat steps 62-76. However, if it is determined at step 76 that there are no more messages to be processed, then the communication system 60 then exits at step 79.

FIG. 3B is a flow chart illustrating an example of the operation of the remote device system 80 with the remote device GPS tracking system 200 on the remote device 15, as shown in FIGS. 1 and 2B. The remote device system 80 negotiates the communication link to use between the remote device 15 and a server 11, and determines if the message is a standard voice data message or an Airo Wireless Telematics Logic message.

First at step 81, the remote device system 80 is initialized. This initialization includes the startup routines and processes embedded in the BIOS of the server 11. The initialization also includes the establishment of data values for particular data structures utilized in the server 11 and remote device system 80. At step 82, the remote device system 80 waits for a client connect or data packet. Upon acquiring or sending a data packet, the remote device system 80 negotiates the communication link speed. At step 83, the negotiate communications link agent is herein defined in further detail with regard to FIG. 8A.

The remote device system 80 then validates the client device ID at step 84. At step 85, it is determined if the client ID for the client connect or data packet is valid. If it is determined at step 85 that the client ID for the communication sent or received is invalid, the remote device system 80 then rejects the connection in step 86 and returns to wait for the next connection at step 82.

However, if it is determined at step 85 that the client ID is valid, then the remote device system 80 determines if the communication is a standard send and receive message at step 91. If it is determined that step 91 that the message is a standard send or receive message, then the message is processed at step 92, utilizing the current voice and data processing as currently available in the art.

However, if it is determined in step 91 that the message received is not a standard message (i.e. an Airo Wireless Telematics Logic message), then the remote device system 80 sends the header and port number in the message to server 11 at step 93. At step 94, the remote device system 80 executes remote device GPS tracking system 200 on the remote device. The GPS tracking system is herein defined in further detail with regard to FIG. 4B.

At step 95, it is determined if there are more messages to be processed. If it is determined at step 95 that there are more messages to be processed, then the remote device system 80 returns to repeat steps 82 through 95. However, if it is determined at step 95 that there are no more messages to be processed, then the remote device system 80 then exits at step 99.

Illustrated in FIG. 4A is a flow chart describing an example of the operation of the exemplar GPS tracking system 100 on a server 11, as shown in FIGS. 1 and 2A. The GPS tracking system 100 enables a user to obtain and submit tracking data with server 11 to be transferred to the remote device 15 and 17-20. The GPS tracking system 100 on server 11 comprises four sub-components: the configuration process 120, the emergency process 140, the tracking process 160, and the negotiate communication link process 180. After the GPS tracking system 100 is initialized, each of these sub-components is initialized and run in the background. Each of these sub-components processes events relevant to their own responsibility until the GPS tracking system 100 is shut down.

First at step 101, the GPS tracking system 100 is initialized. This initialization includes the startup routines and processes embedded in the BIOS of the server 11. The initialization also includes the establishment of data values for particular data structures utilized in the server 11 and GPS tracking system 100.

At step 102, the GPS tracking system 100 determines if the link the message was received on is valid. After successful connection, the remote device 15 sends its device ID and authentication information to the server 11 in order to identify itself. The message is then removed from the transmission envelope and is checked to make sure it is a valid message. If the message is a valid message, the sequence number in the message is examined to see if it is a message that has already been processed. The remote device 15 may send/receive multiple messages with the same sequence number if the remote device 15 has been out of coverage and if the server 11 has retried the transmission.

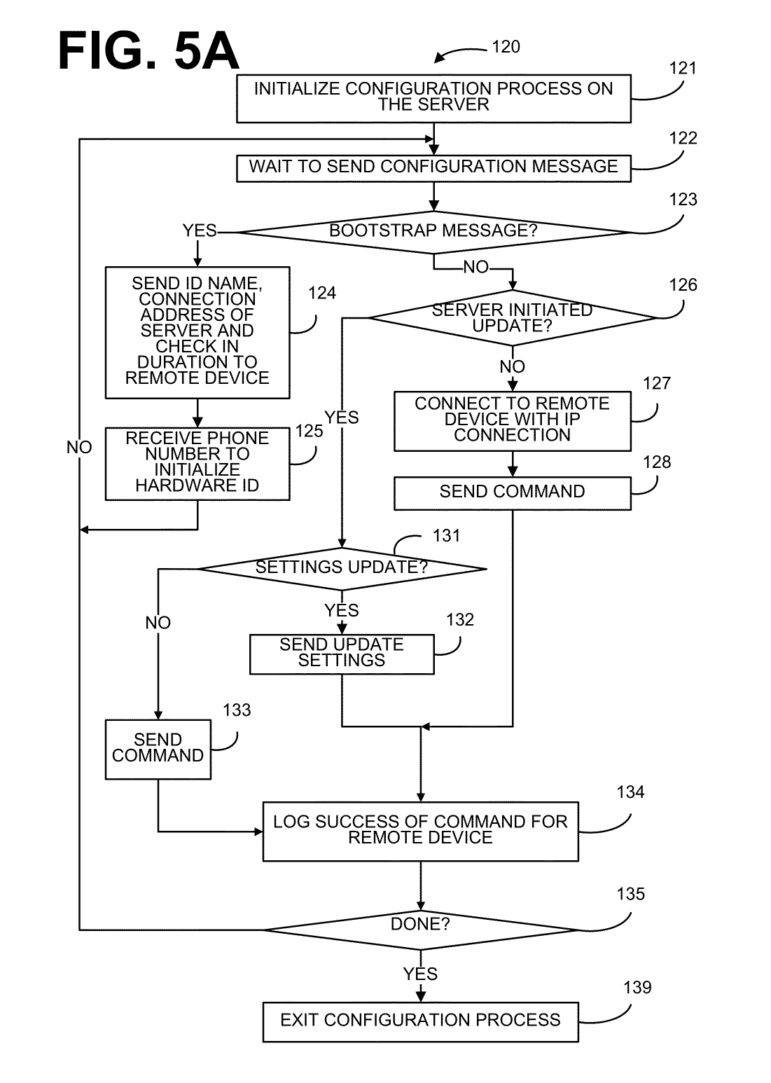

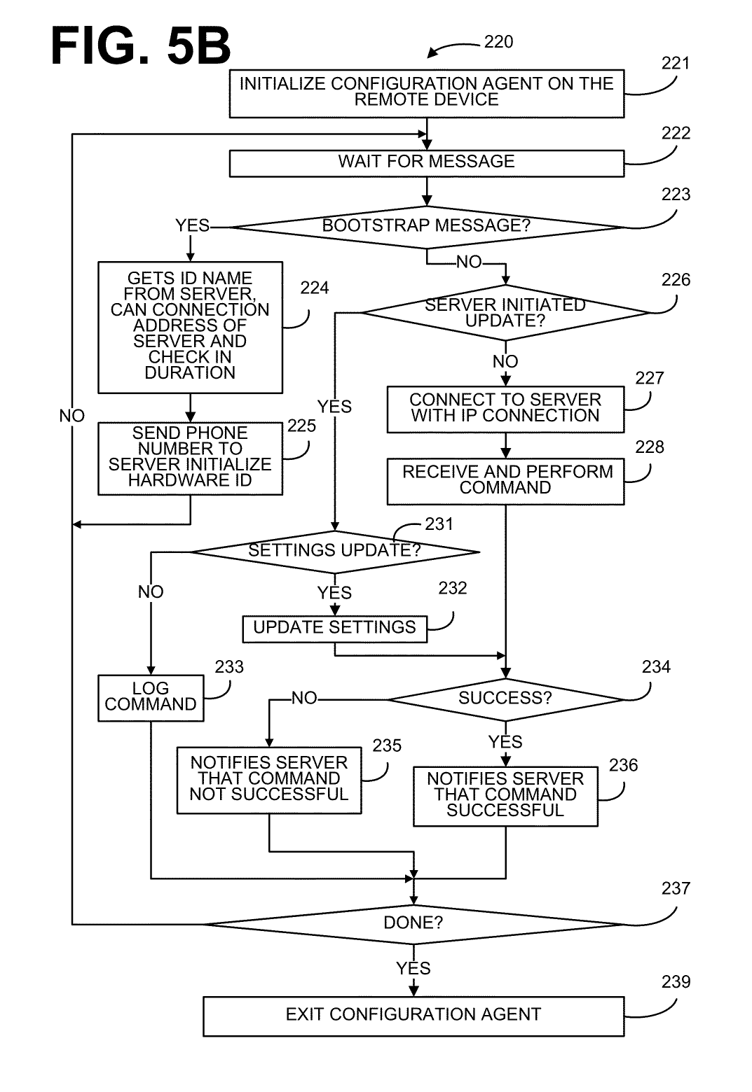

If it is determined in step 102 that the link is not valid, then the GPS tracking system 100 skips to exit at step 119. However, if it is determined at step 102 that link the message was received from is valid, and then the GPS tracking system 100 enables the selection of permitted processes at step 103. At step 104, it is determined if the configuration process is selected. If it is determined in step 104 that the configuration process was not selected, then the GPS tracking system 100 skips to step 106. However, if it is determined at step 104 that the configuration process was selected, then the configuration process is performed at step 105. The configuration process is herein defined in further detail with regard to FIG. 5A.

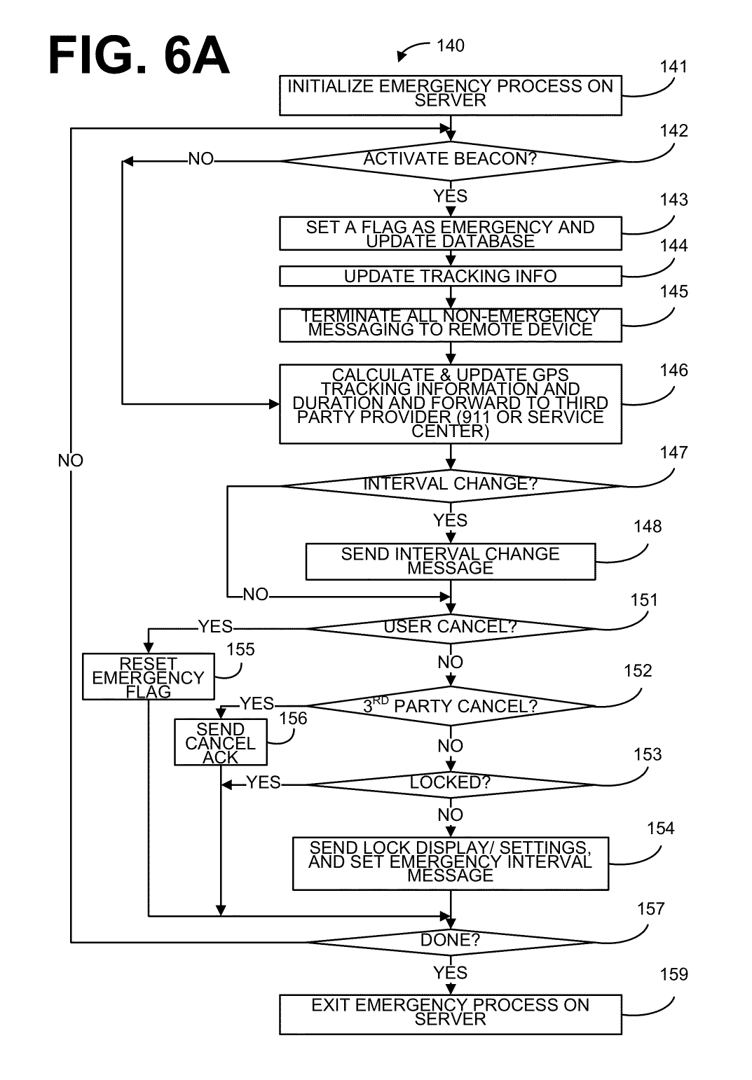

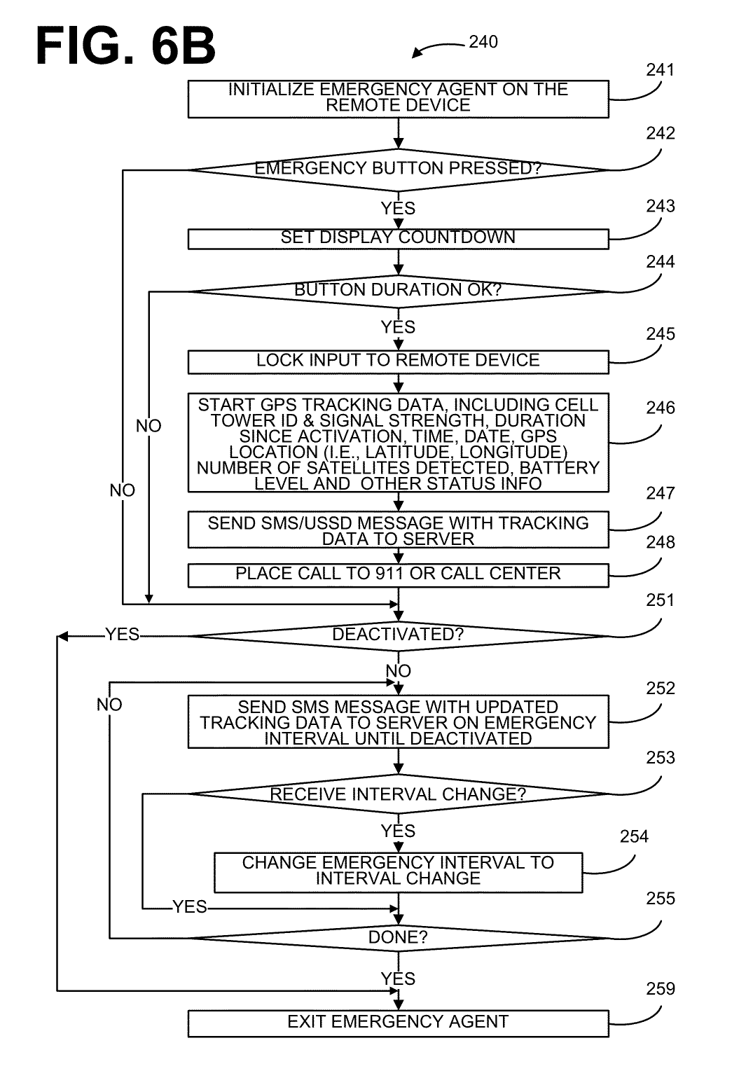

At step 106, it is determined if the emergency process is selected. If it is determined at step 106 that the emergency process is not selected, then the GPS tracking system 100 skips the step 112. However, if it is determined at step 106 that the emergency process was selected, then the emergency process is executed at step 111. The emergency process is herein defined in further detail with regard to FIG. 6A.

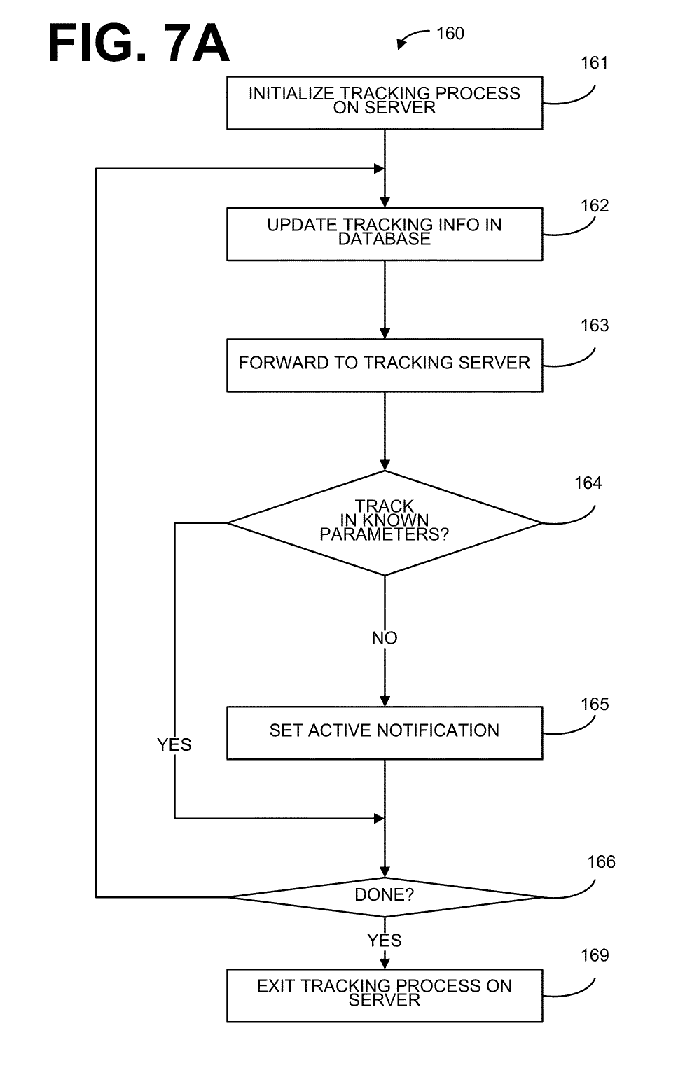

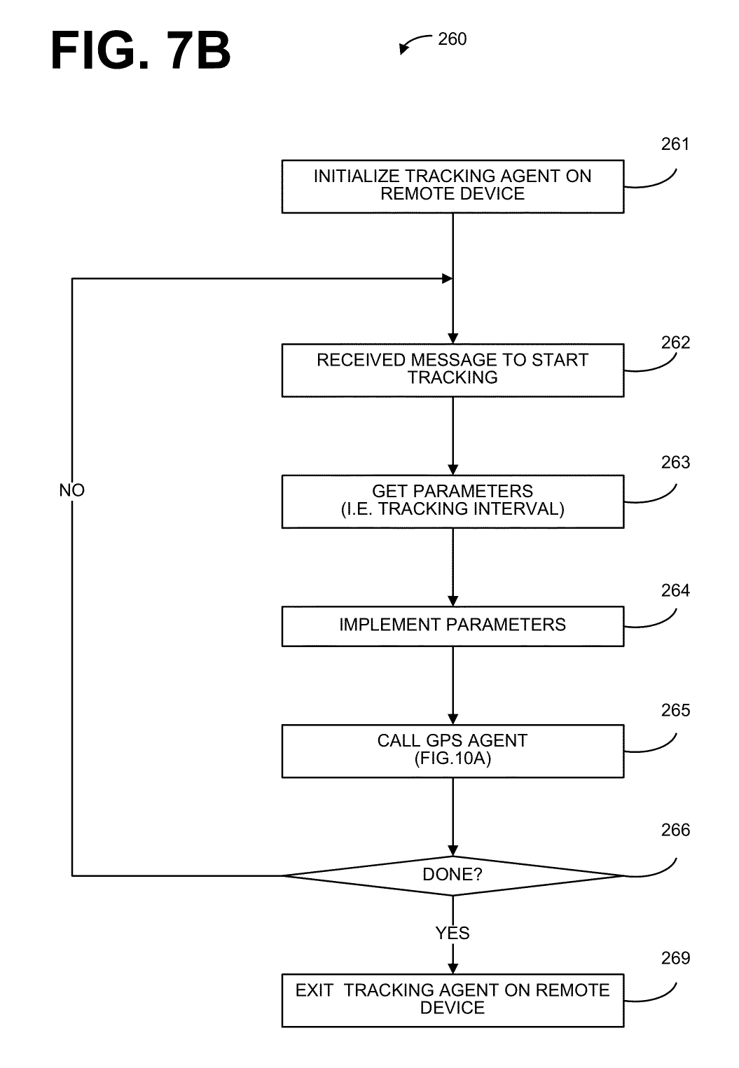

At step 112, it is determined that the tracking process is selected. If it is determined at step 112 that the tracking process was not selected, and the GPS tracking system 100 skips to step 114. However, if it is determined at step 112 at the tracking process was selected, then the tracking process is executed at step 113. The tracking process is herein defined in further detail with regard to FIG. 7A.

At step 114, it is determined that there are more messages and processes to be performed. If it is determined at step 114 that there are more messages and processes to be performed, then the GPS tracking system 100 returns to repeat steps 102 through 114. However, if it is determined at step 114 that there are no more processes or messages to be performed, then the GPS tracking system 100 exits at step 119.

Illustrated in FIG. 4B is a flow chart describing an example of the operation of remote device GPS tracking system 200 with the battery extension system of the present invention on a remote device 15, as shown in FIGS. 1 and 2B. The remote device GPS tracking system 200 enables a user to obtain and submit tracking data with server 11 from the remote device 15. Remote device GPS tracking system 200 on remote device 15 comprises 7 sub-components: the configuration agent 220, the emergency agent 240, the tracking agent 260, the negotiate communication link agent 280, the flashlight agent 320, the GPS agent 340 and the sleep agent 360 of the present invention. After the remote device GPS tracking system 200 is initialized, each of these sub-components is initialized and run in the background. Each of these sub-components processes events relevant to their own responsibility until the remote device GPS tracking system 200 is shut down.

First at step 201, remote device GPS tracking system 200 is initialized. This initialization includes the startup routines and processes embedded in the BIOS of the remote device 15. The initialization also includes the establishment of data values for particular data structures utilized in the remote device 15 and remote device GPS tracking system 200.

At step 202, remote device GPS tracking system 200 determines if the link the message was received on is valid. If it is determined in step 202 that the link is not valid, then remote device GPS tracking system 200 skips to exit at step 219. However, if it is determined at step 202 that link the message was received from is valid, then remote device GPS tracking system 200 displays the permitted functions and sends the selection to the server 11 at step 203. At step 204, it is determined if the configuration agent is selected. If it is determined in step 204 that the configuration agent was not selected, then remote device GPS tracking system 200 skips to step 206. However, if it is determined at step 204 that the configuration agent was selected, then the configuration agent is performed at step 205. The configuration agent is herein defined in further detail with regard to FIG. 5B.

At step 206, it is determined if the emergency agent is selected. If it is determined at step 206 that the emergency agent is not selected, then remote device GPS tracking system 200 skips the step 211. However, if it is determined at step 206 that the emergency agent was selected, then the emergency agent is executed at step 207. The emergency agent is herein defined in further detail with regard to FIG. 6B.

At step 211, it is determined if the tracking agent is selected. If it is determined at step 211 that the tracking agent was not selected, then remote device GPS tracking system 200 skips to step 213. However, if it is determined at step 211 that the tracking agent was selected, then the tracking agent is executed at step 212. The tracking agent is herein defined in further detail with regard to FIG. 7B.

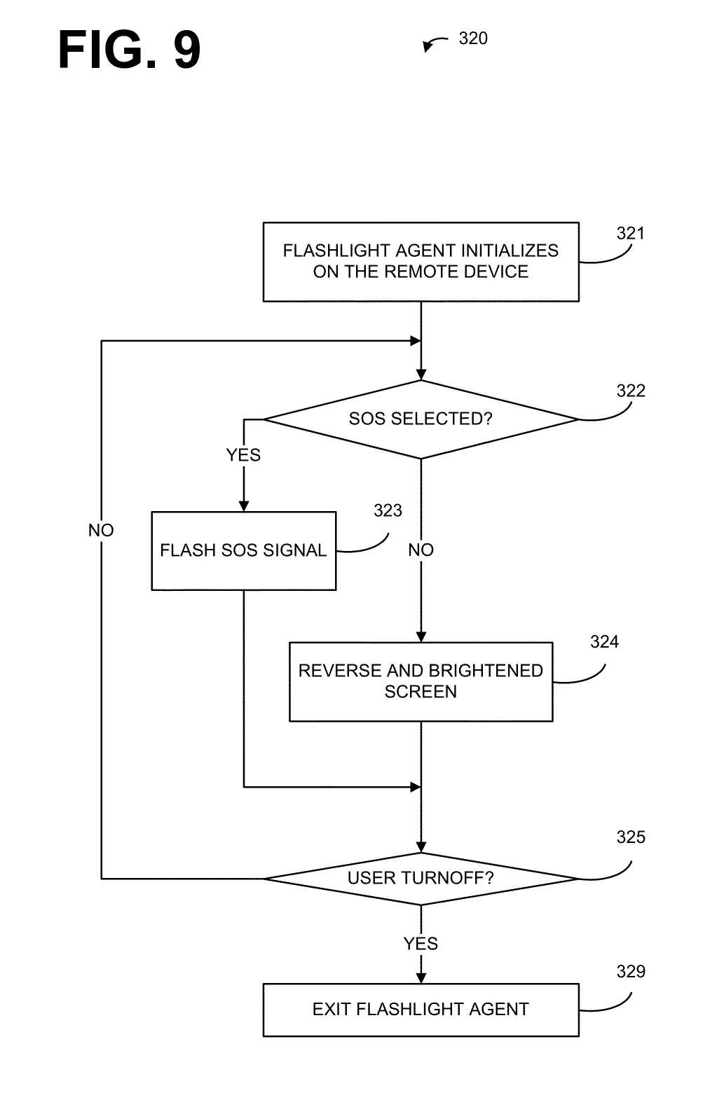

At step 213, it is determined if the flashlight agent is selected. If it is determined that step 213 at the flashlight agent is not selected, then remote device GPS tracking system 200 skips to step 215. However, if it is determined at step 213 that the flashlight agent was selected, then the flashlight agent is executed at step 214. The flashlight agent is herein defined in further detail with regard to FIG. 9.

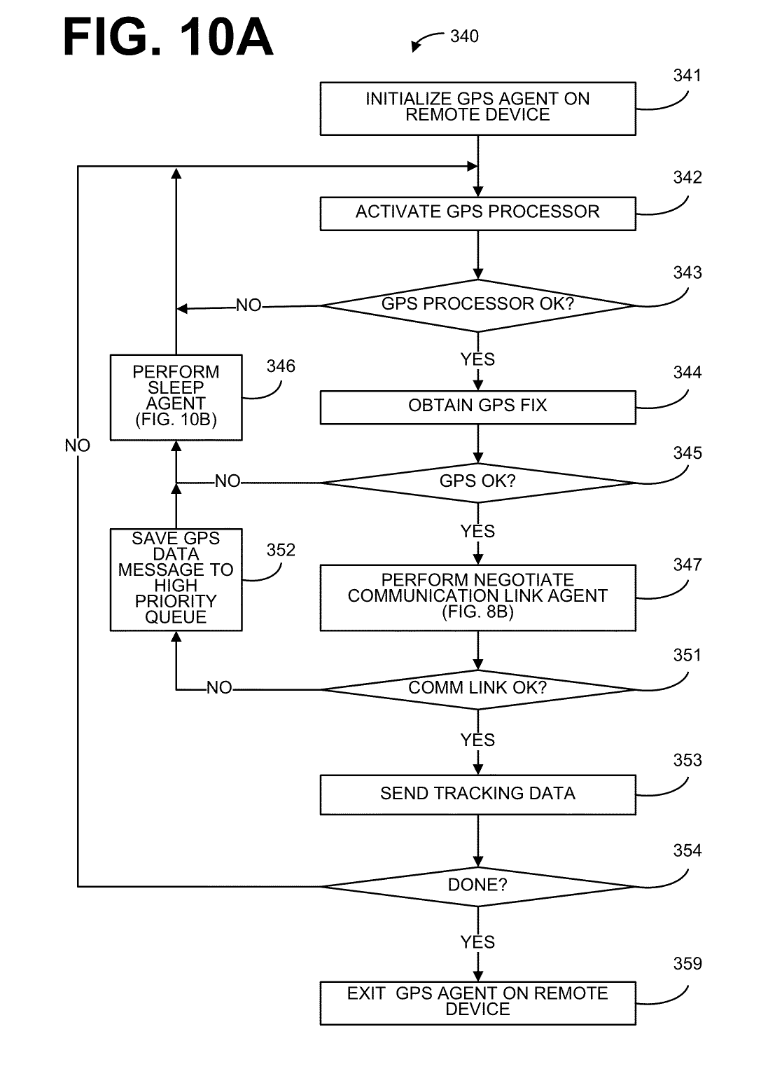

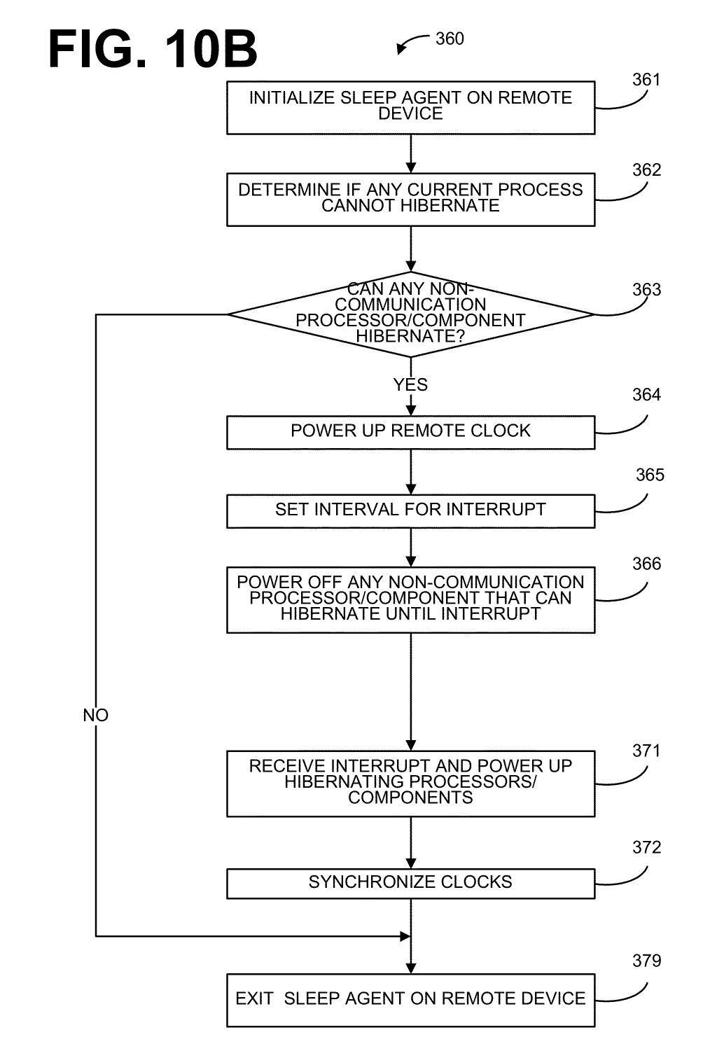

At step 215, it is determined, if nothing is selected. If it is determined that step 215 that something was selected, then remote device GPS tracking system 200 skips to step 217. However, if it is determined at step 215 that nothing was selected, then the sleep agent is executed at step 216. The sleep agent is herein defined in further detail with regard to FIG. 10B. The sleep agent attempts to conserve the battery when the device is on, but not currently performing a critical task. In one embodiment of the present invention, the sleep agent is performed instead of placing the device in standby or hibernation.

At step 217, it is determined that there are more messages and processes to be performed. If it is determined at step 217 that there are more messages and processes to be performed, then remote device GPS tracking system 200 returns to repeat steps 202 through 217. However, if it is determined at step 217 that there are no more processes or messages to be performed, then the remote device GPS tracking system 200 exit that step 219.

Illustrated in FIG. 5A is a flow chart describing an example of the operation of the configuration process 120 on a server 11 utilized in the exemplar GPS tracking system 100, as shown in FIGS. 1-3. The configuration process 120 collects the updates required to be pushed down or requested to remote device 15. The configuration process 120, after initialization, listens on a configurable port for connections from clients or a configuration message from server 11 at step 122.

After it receives a client connection from remote device 15 or configuration message from server 11, it determines if the configuration message to be sent to the remote device 15 is a bootstrap message at step 123. If it is determined at step 123 that a bootstrap message is not to be sent, then the configuration process 120 then skips to step 126. However, if it is determined at step 123, the bootstrap message is to be sent, the configuration process 120 sends the ID name, connection address of the server 11, and the check-in duration to remote device 15 at step 124. The configuration process 120 then returns to repeat steps 122 through 135.

In step 126, the configuration process 120 determines if the configuration message for remote device 15 is a server initiated update. If it is determined at step 126 that the message is a server initiated update, then the configuration process 120 skips to step 131. However, if it is determined at step 126 that the configuration message is not a server initiated update, then the configuration process 120 connects to the remote device 15 with an IP connection via an internet protocol (IP) socket at step 127. At step 128 the configuration process 120 sends the configuration command to the remote device 15 on the established IP connection. The configuration process 120 then skips to step 134.

At step 131, the configuration process 120 determines if the server initiated update is a settings update. If it is determined in step 131 that the update message is a settings update, then update settings are sent from the configuration process 120 to the remote device 15 at step 132. The configuration process 120 then skips to step 134. However, if it is determined at step 131 that the server initiated update is not a settings update, and the configuration process 120 sends the configuration command at step 133.

At step 134, the configuration process 120 then logs the success of the command or update for the remote device 15. At step 135, it is determined that there are more configuration messages to be processed. If it is determined at step 135 that there are more configuration messages to be processed, then the configuration process 120 returns to repeat steps 122 through 135. However, if it is determined at step 135 that there are no more configuration messages to be processed, then the configuration process 120 exits at step 139.

In an alternative embodiment, the configuration process 120 will maintain a connection to the client on the remote device 15 until the client terminates the connection.

Illustrated in FIG. 5B is a flow chart describing an example of the operation of the configuration agent 220 on a remote device 15 utilized in remote device GPS tracking system 200, as shown in FIGS. 1-4B. The configuration agent 220 collects the updates required to be pushed down or requested by remote device 15. The configuration agent 220, after initialization, listens on a configurable port for connections or a configuration message from server 11 at step 222.

After it receives a connection or configuration message from server 11, configuration agent 220 determines if the configuration message being sent to the remote device 15 is a bootstrap message at step 223. If it is determined at step 223 that a bootstrap message is not to be sent, then the configuration agent 220 then skips the step 226. However, if it is determined at step 223, the bootstrap message is to be sent, the configuration agent 220 receives the ID name, connection address of the server 11, and the check-in duration for the remote device 15 at step 224. The configuration agent 220 then returns to repeat steps 222 through 237.

Step 226, the configuration agent 220 determines if the configuration message for remote device 15 is a server initiated update. If it is determined at step 226 that the message is a server initiated update, then the configuration agent 220 skips to step 231. However, if it is determined at step 226 that the configuration message is not a server initiated update, then the configuration agent 220 connects the remote device 15 to server 11 with an IP connection via an internet protocol (IP) socket at step 227. At step 228 the configuration agent 220 receives the configuration command to the remote device 15 on the established IP connection. The configuration agent 220 then skips to step 234.

At step 231, the configuration agent 220 determines if the server initiated update is a settings update. If it is determined in step 231 that the update message is a settings update, then update settings is processed for the remote device by the configuration agent 220 at step 232. The configuration agent 220 then skips to step 234. However, if it is determined at step 231 that the server initiated update is not a settings update, and then the configuration agent 220 logs the configuration command at step 233.

At step 234, the configuration agent 220 then determines if the update was a success. If the update was applied with success, then the configuration agent 220 then notifies the server 11 that the command was successfully applied at step 236. Otherwise, if it is determined at step 234 that the update was not a success, then the configuration agent 220 notifies the server 11 that the command update was not successful at step 235.

At step 237, it is determined if there are more configuration messages to be processed. If it is determined at step 237 that there are more configuration messages to be processed, then the configuration agent 220 returns to repeat steps 222 through 237. However, if it is determined at step 237 that there are no more configuration messages to be processed, then the configuration agent 220 exits at step 239.

Illustrated in FIG. 6A is a flow chart describing an example of the operation of the emergency process 140 utilized by the exemplar GPS tracking system 100, as shown in FIGS. 2A-4A. The emergency process 140 collects tracking information from remote device 15 in order to calculate updated GPS tracking information, and forwarding that information onto third-party providers such as 911 or service centers.

First, the emergency process 140 is initialized on the server 11 at step 141, and performs similar functions as the initialization of the GPS tracking system 100 as described above. The initialization also includes the establishment of data values for particular data structures utilized in the emergency process 140. At step 142, the emergency process 140 determines if the message received is to activate an emergency beacon. If it is determined at step 142 that the message received is not to activate an emergency beacon, then the emergency process 140 then skips to step 146.

However, if it is determined that message received is to activate an emergency beacon or is updating information with regard to emergency process that is flagged as an emergency, then the emergency process 140 sets a flag in database 12, indicating that remote device 15 has an emergency. At step 144, updated tracking information is received. At step 145, the emergency process 140 terminates all non-emergency messaging to the remote device 15. This is done in order to prohibit any occurrence of a server 11 from distracting the user of remote device 15, limit usage of available network bandwidth, limit remote device processing power and control battery usage.

At step 146, emergency process 140 calculates the updated GPS tracking information in the duration of the emergency and forwards this data to third-party providers such as 911 or a service center. The third party provider or service center indicated would be third party server 21 and databases 22 (FIG. 1).

At step 151, the emergency process 140 determines if the user of a remote device 15 is canceling the emergency. The user would cancel the emergency by deactivating the emergency button. If it is determined at step 151 that the user is canceling the emergency, then the emergency process 140 resets the emergency flag in database 12 for the remote device 15 and skips to step 156. In an alternative embodiment, the user cannot cancel the emergency activation and the remote device 15 locks automatically.

However, if it is determined at step 151 that the user is not canceling the emergency, then the emergency process 140 determines if the third party is canceling the emergency at step 152. If it is determined at step 152 that a third party is not canceling the emergency, then the emergency process 140 locks the remote device 15 in the emergency state on the remote device at step 153, and then skips to step 156. However, if it is determined at step 152 that a third party is canceling the emergency, the emergency process 140 sends a cancel and acknowledgment at step 154 and skips to step 156.

At step 156, the emergency process 140 of the present invention determines if more emergency messages are to be processed. If it is determined at step 156 that there are more emergency messages to be processed, the emergency process 140 then returns to repeat steps 142 through 156. However, if it is determined at step 156 that there are no more emergency messages to be processed, then the emergency process 140 exits at step 159.

Illustrated in FIG. 6B is a flow chart describing an example of the operation of the emergency agent 240 utilized by remote device GPS tracking system 200, as shown in FIGS. 2A-4B. The emergency agent 240 collects tracking information on remote device 15 in order to send emergency GPS tracking information to server 11.

First, the emergency agent 240 is initialized on the remote device 15 at step 241, and performs similar functions as the initialization of remote device GPS tracking system 200 as described above. The initialization also includes the establishment of data values for particular data structures utilized in the emergency agent 240. At step 242, the emergency agent 240 determines if the message received is to activate an emergency. In the preferred embodiment, an emergency is activated by pressing the emergency button. If it is determined at step 242 that the emergency button was not pressed, then the emergency agent 240 then skips to step 253.

However, if it is determined that the emergency button was pressed, and then the emergency agent to 240 then sets the display countdown at step 243. The displayed countdown of the amount of time that the user has to deactivate the emergency button before the emergency sequence is placed into service.

At step 244, it is determined if the emergency button was the pressed longer than the display countdown. This is an order to enable a user to deactivate an emergency process before the emergency sequence is placed into service. If it is determined at step 244 that the emergency button duration was not sufficient, then the emergency agent to 240 then skips to step 253.

However, if it is determined at step 244 that the button was depressed for a sufficient duration, the emergency agent to 240 blocks the input to the remote device 15 at step 245. At step 246, the remote device 15 starts the GPS tracking data including ID cell tower signal strength, duration since activation, date and time of the message, GPS location then includes latitude and longitude, the number of satellites detected by the remote device and the battery level of the remote device and any other required status information.

At step 251, the emergency agent to 240 then sends an SMS message with the tracking data to server 11 indicating that there is an emergency situation. At step 252, emergency agent to 240 then places a call to 911 or a user defined pre-set third-party call center.

At step 253, the emergency agent 240 determines if the user deactivates the emergency process. If it is determined in step 253 that the user does deactivate the emergency situation, then the emergency agent 240 then returns to repeat steps 242 through 255. However, if it is determined in step 253 that the user did not attempt to deactivate the emergency situation, then the emergency agent 240 sends an SMS message with updated tracking data to server 11 on a predetermined time interval until the emergency agent 240 is deactivated

At step 255, the emergency agent 240 of the present invention determines if more emergency messages are to be processed. If it is determined at step 255 that there are more emergency messages to be processed, and the emergency agent 240 then returns to repeat steps 242 through 256. However, if it is determined at step 256 that there are no more emergency messages to be processed, then the emergency agent 240 exits at step 259.

Illustrated in FIG. 7A is a flow chart describing an example of the operation of the tracking process 160 utilized by the exemplar GPS tracking system 100, as shown in FIGS. 2A-4A. The tracking process 160 is responsible for non-emergency tracking information and determining if the remote device being tracked is within the parameters.

First, at step 161, the tracking process 160 is initialized on the server 11 and performs similar functions as the initialization of the GPS tracking system 100 as described above. The initialization also includes the establishment of data values for particular data structures utilized in the tracking process 160.

At step 162, the tracking process 160 receives tracking information from the remote device 15 and updates the tracking information in database 12. At step 163, the tracking process 160 forwards the tracking information to a tracking server or third party server 21. This is in order to provide tracking information to an enterprise.

At step 164, it is determined that the track information is within known parameters. This determines that the track of the remote device 15 is within predetermined boundaries. In one example, the remote device could be assigned to an operator of delivery trucks such as for example, but not limited to, UPS trucks, United States Postal Service, Federal Express or the like. In other examples, the remote device 15 could be provided to one's teenage child to make sure that the child does not go out of state. If it is determined in step 164 that the track information is not within known parameters, and the tracking process 160 skips to step 166.

At step 165, if the tracking data is within known parameters it sets an active notification to the third party server 21.

At step 166, it is determined if there are more tracking messages to be processed. If it is determined that there are more tracking messages to be processed, then the tracking process 160 returns to repeat steps 162 through 166. However, if it is determined at step 166 that there are no more tracking messages to be processed, then the tracking process 160 exits at step 169.

Illustrated in FIG. 7B is a flow chart describing an example of the operation of the tracking agent 260 utilized by remote device GPS tracking system 200 of the present invention, as shown in FIGS. 2B-4B. The tracking agent 260 is responsible for non-emergency tracking information collected by the remote device 15.

First, at step 261, the tracking agent 260 is initialized on the remote device 15 and performs similar functions as the initialization of remote device GPS tracking system 200 as described above. The initialization also includes the establishment of data values for particular data structures utilized in the tracking agent 260.

At step 262, the tracking agent 260 receives a message to start collecting tracking information on the remote device 15. At step 263, in tracking agent to 260 gets various GPS tracking information. The GPS tracking information, collected includes, but are is not limited to, cell tower ID, signal strength, duration since activation of the tracking, date and time of the tracking parameters, GPS location including latitude and longitude, number of satellites detected, the altitude of the remote device, and other status info.

At step 264, the parameters are implemented. The handset starts recording and sending of location data based on the parameters.

At step 265, the tracking agent calls the GPS agent. The GPS agent generates tracking data based on the GPS hardware on remote device 15. The GPS agent is herein defined in further detail with regard FIG. 10A.

At step 266, it is determined if more tracking data is to be generated. If it is determined that there are more tracking messages to be generated, then the tracking agent 260 returns to repeat steps 262 through 266. However, if it is determined at step 266 that there are no more tracking messages to be generated, then the tracking agent 260 exits at step 269.

Illustrated in FIG. 8A is a flow chart describing an example of the operation of the negotiate communication link process 180 utilized by the Exemplar GPS tracking system 100 on server 11, as shown in FIGS. 2A-4A. The negotiate communication link process 180 starts the message processing by determining the priority and communication link needed by a message to be sent or received.

Once the priority of a message is determined, the negotiate communication link process 180 will determine which communication method to use in order to transmit or receive the message. If the negotiate communication link process 180 has registered the server 11 as IP capable, the message will be sent over the IP link. Otherwise, the message will be sent via SMS via SMPP or other protocols if the server 11 is SMS capable.

First, at step 181, the negotiate communication link process 180 is initialized on the server 11 and performs similar functions as the initialization of the GPS tracking system 100 as described above. The initialization also includes the establishment of data values for particular data structures utilized in the negotiate communication link process 180.

At step 182, the priority of the message to be sent or received on server 11 is determined. At step 183, it is determined if the message to be sent or received is high priority. If it is determined at step 183 that the message to be sent or received is not a high priority, then the negotiate communication link process 180 proceeds to step 188. However, if it is determined at step 183 that the message to be sent or received is high priority, then the negotiate communication link process 180 determines if the message is to be sent at step 184. If it is determined at step 184 that the message is not to be sent, then the negotiate communication link process 180 skip to step 187.

However, if it is determined at step 184 that the message to be processed is a high-priority send message, then the message is converted to SMS or USSD. The negotiate communication link process 180 will attempt to send a message via SMS via SMPP or other protocols before dropping down to the default of USSD at step 186. The negotiate communication link process 180 then skips to step 196.

At step 187, the negotiate communication link process 180 places the message received in the high priority queue and then skips to step 196.

At step 188, it is determined if the normal priority message is to be sent. If it is determined at step 188 that the normal message is not to be sent, but instead to be received, then the negotiate communication link process 180 then skips to step 195. However, if it is determined at step 188 that the normal priority message is to be sent, then it determines in step 191 if an IP connection is available for the message. If it is determined in step 191 that an IP connection is not available, then the negotiate communication link process 180 send a message via SMS or USSD by repeating steps 185 through 186. However, if it is determined at step 191 that an IP connection is available, then the negotiate communication link process 180 sends the message at step 192 utilizing the IP communication link.

At step 193, it is determined if the IP message was successfully sent. If it is determined at step 193 that the IP message was successfully sent, the negotiate communication link process 180 then skips to step 196. However, if it is determined at step 193 that the IP message was not successfully sent, then the negotiate communication link process 180 determines if the maximum retry limit for sending a message on any IP communication link has been reached at step 194.

If it is determined that the maximum retry count has been reached, then the negotiate communication link process 180 changes the communication link being utilized by sending the message via SMS or USSD by repeating steps 185 through 186. However, if it is determined at step 194 that the maximum retry count had not been exceeded, then the negotiate communication link process 180 repeats steps 192 and 193 to attempt to resend the message using the IP connection.

At step 195, the negotiate communication link process 180 places the normal priority message being received in the normal queue on server 11.

At step 196, the negotiate communication link process 180 determines if there are more messages to be sent and received. If it is determined at step 196 that there are more messages to be sent and received, the negotiate communication link process 180 then returns to repeat steps 182 through 196. However, if it is determined that there are no more messages to be sent or received, the negotiate communication link process 180 then exits at step 199.

Illustrated in FIG. 8B is a flow chart describing an example of the operation of the negotiate communication link agent 280 utilized by remote device GPS tracking system 200 of the present invention, as shown in FIGS. 2B-4B. The negotiate communication link agent 280 starts the message process by determining the priority and communication link utilized by a message to be sent or received on remote device 15.

Once the priority of a message is determined, the negotiate communication link agent 280 will determine which communication method to use in order to transmit or receive the message. If the negotiate communication link agent 280 has registered the remote device 15 as IP capable, the message will be sent over the IP link. Otherwise, the message will be sent via SMS over SMPP or other protocols if the device is SMS capable.

First, at step 281, the negotiate communication link agent 280 is initialized on the remote device 15 and performs similar functions as the initialization of remote device GPS tracking system 200 as described above. The initialization also includes the establishment of data values for particular data structures utilized in the negotiate communication link agent 280.

At step 282, the priority of the message to be sent or received on the remote device 15 is determined. At step 283, it is determined if the message to be sent or received is high priority. If it is determined at step 283 that the message to be sent or received is not a high priority, then the negotiate communication link agent 280 proceeds to step 288. However, if it is determined at step 283 that the message to be sent or received is high priority, then the negotiate communication link agent 280 determines if the message is to be sent at step 284. If it is determined at step 284 that the message is not to be sent, then the negotiate communication link agent 280 skips to step 287.

However, if it is determined at step 284 that the message to be sent is a high-priority send message, then the message is converted to SMS or USSD. The negotiate communication link agent 280 on the remote device 15 will attempt to send a message via SMS over SMPP or other protocols before dropping down to the default of USSD at step 286. The negotiate communication link agent 280 then skips to step 296.

At step 287, the negotiate communication link agent 280 places the message received in the high priority queue and then skips to step 296.

At step 288, it is determined if the normal priority message is to be sent. If it is determined at step 288 that the normal message is not to be sent, but instead to be received, then the negotiate communication link agent 280 then skips to step 295. However, if it is determined at step 288 that the normal priority message is to be sent, then it determines in step 291 if an IP connection is available for the message. If it is determined in step 291 that an IP connection is not available, then the negotiate communication link agent 280 send a message via SMS or USSD by repeating steps 285 through 286. However, if it is determined at step 291 that an IP connection is available, then the negotiate communication link agent 280 sends the message at step 282 utilizing the IP communication link.

At step 293, it is determined if the IP message was successfully sent. If it is determined at step 293 that the IP message was successfully sent, the negotiate communication link agent 280 then skips to step 296. However, if it is determined at step 293 that the IP message was not successfully sent, then the negotiate communication link agent 280 determines if the maximum retry limit for sending a message on any IP communication link has been reached at step 294. If it is determined that the maximum retry count has been reached, then the negotiate communication link agent 280 changes the communication link being utilized by sending the message via SMS or USSD by repeating steps 285 through 286. However, if it is determined at step 294 that the maximum retry count had not been exceeded, then the negotiate communication link agent 280 repeats steps 292 and 293 to attempt to resend the message using the IP connection on remote device 15.

At step 295, the negotiate communication link agent 280 places the normal priority message being received in the normal queue on remote device 15.

At step 296, the negotiate communication link agent 280 determines if there are more messages to be sent and received. If it is determined at step 296 that there are more messages to be sent and received, then the negotiate communication link agent 280 then returns to repeat steps 282 through 296. However, it is determined that there are no more messages to be sent or received, then the negotiate communication link agent 280 then exits at step 299.

Illustrated in FIG. 9 is a flow chart describing an example of the operation of the flashlight agent 320 utilized on the remote device 15 for remote device GPS tracking system 200 of the present invention, as shown in FIGS. 1 and 2B. The flashlight agent 320 energizes the screen so that it may act as a flashlight.

First, at step 321, the flashlight agent 320 is initialized on the remote device 15. The initialization also includes the establishment of data values for particular data structures utilized in the flashlight agent 320.

At step 322, it is determined if the SOS function is selected. If it is determined at step 322 that the flash SOS signal is selected, then the flashlight agent 320 then flashes the SOS signal at step 323 and skips to step 325. However, if it is determined at step 322 that the SOS is not selected, then the flashlight agent reverses and brightens the screen of the remote device 15 at step 324.

At step 325, the flashlight agent determines if the user has initiated the turnoff of either the flash SOS signal or the screen brighten function. If it is determined at step 325 that the user has not turned off the SOS signal or the screen brighten signal, then the flashlight agent 320 then returns to repeat steps 322-325. Otherwise, the flashlight agent 320 turns off the SOS signal or the screen-brighten signal at step 325 and exits at step 329.

FIG. 10A is a flow chart illustrating an example of the operation of the GPS agent 340 utilized on the remote device for the exemplarily GPS tracking system with the battery extension system of the present invention, as shown in FIG. 7B. The GPS agent 340 acquires GPS information and communicates the GPS information back to the exemplarily GPS tracking system 100 on server 11. The GPS agent 340 also utilizes the battery extension system of the present invention, where applicable to maximize the battery life between the transmissions of GPS information.

First, at step 341, the GPS agent 340 is initialized on the remote device 15 and performs similar functions as the initialization of remote device GPS tracking system 200 as described above. The initialization also includes the establishment of data values for particular data structures utilized in the GPS agent 340.

At step 342, the GPS agent 340 activates the GPS processor (not shown). At step 343, the GPS agent 340 determines if the GPS processor is operating normally. If it is determined that the GPS processor is not operating normally, then the GPS agent 340 then returns to step 342 to reattempt the activation of the GPS processor. If it is determined at step 343 that the GPS processor is operating normally, then the GPS agent 340 obtained a GPS position fix of the remote device 15 at step 344. At step 345, the GPS agent 340 then determines if the GPS position fix was successfully acquired. If it is determined at step 345 that the attempt to obtain the GPS position fix was successful, then the GPS agent 340 then skips the step 347.

If it is determined at step 345, that the attempt to obtain the GPS position was unsuccessful, then the GPS agent 340 calls the sleep agent at step 346. The sleep agent provides the battery extension system of the present invention, where applicable to maximize the battery life between the transmissions of GPS information. The sleep agent is herein defined in further detail with regard to FIG. 10B. After performing the sleep agent, the GPS agent 340 returns to repeat step 342-345.

At step 347, the GPS agent 340 performs the negotiate communication link agent 280 then attempts to transmit the GPS position data to the GPS tracking system 100 on server 11. The negotiate communication link agent 280 was defined herein in further detail with regard FIG. 8B. At step 351, it is determined if the communication link negotiated at step 347 is operational. If it is determined at, step 351, that the communication link negotiated at step 347 is operational, then the GPS agent 340 skips to step 353.

However, if it is determined at step 351 that the communication link negotiated at step 347 is not operational, then the GPS agent 340 then saves the GPS data message to a high priority queue at step 352. After saving the data, the GPS agent 340 then performs the sleep agent at step 346. As stated previously, the sleep agent is herein defined in further detail with regard to FIG. 10B. The sleep agent attempts to determine if any current process, processor or component within the remote device 15 can hibernate, (i.e. powered off for a limited time). After performing the sleep agent at step 346, the GPS agent 340 then returns to repeat steps 342 through 351.

At step 353, the GPS agent 340 then sends the tracking data to the GPS tracking system 100 on server 11. At step 354, the GPS agent 340 determines if there are more GPS positions to acquire. If it is determined at step 354 that there are more GPS positions to acquire, then the GPS agent 340 returns to repeat steps 342-354. However, if it is determined at step 354 that there are no more GPS positions to obtain, then the GPS agent 340, then exits at step 359.

FIG. 10B is a flow chart illustrating example of the operation of the sleep agent 360 utilized on the remote device 15 with the remote device GPS tracking system 200 with the battery extension system of the present invention, as shown in FIGS. 4B and 10A. The sleep agent attempts to conserve the battery when the device is on, but not currently performing a critical task. In one embodiment of the present invention, the sleep agent is performed instead of placing the device in standby or hibernation.

First, at step 361, the sleep agent 360 is initialized on the remote device 15 and performs similar functions as the initialization of remote device GPS tracking system 200 as described above. The initialization also includes the establishment of data values for particular data structures utilized in the sleep agent 360.

At step 362, the sleep agent 360 determines if any current process or processes cannot hibernate. The hibernation is the temporary interruption of power to the processor or component on remote device 15 for a user selected predetermined time. At step 263, it is determined if any non-communication processor or component can hibernate. If it is determined at step 363 that no non-communication processor or component is available for hibernation, then the sleep agent 360 skips to step 379. However, if it is determined at step 363 that at least one non-communication processor or component is available for hibernation, then the sleep agent 360 powers up the remote clock (FIG. 2B, item 59A) at step 364. The power up process also includes the synchronization of the remote clock (FIG. 2B, item 59A) with the system clock (FIG. 2B, item 58) for the at least one non-communication processor or component is available for hibernation. At step 365, the sleep agent 360 such the interval for interrupt. In one embodiment, the user selects the interval for interrupt of a factory preset time or a user setting. Wherein the user setting comprises different interval settings for different operating environments. Operating environments include, but are not limited to: casual, business, hazardous, dangerous, intrinsically safe and the like. In a casual environment, the interval for interrupt may be greater since the user is not expecting an important condition check. In a business environment, the interval for interrupt will be smaller than a casual environment, but greater than that of a hazardous, flammable or dangerous environment, because the user is expecting an important condition check. In a hazardous environment, the interval for interrupt is smaller (i.e. shorter) than that of the business environment, because the user is expecting critical condition checks. In addition, in a hazardous environment, the interval is smaller because it may be providing important information about the user to an entity managing the hazardous environment. In a dangerous environment, the interval for interrupt may be the smallest interval, because the user wishes to maintain almost constant communication because of the dangerous environment.

In an intrinsically safe controlled environment, the interval is set to zero because of the concern that voltage surges could cause the device 15 to potentially spark.

In one embodiment, the user would detect whether or not the device 15 is entering an intrinsically safe controlled environment and select the intrinsically safe interval setting. In another embodiment, it is possible that the device 15 could detect, via Bluetooth, WiFi, or other electronic signals that the areas that the device 15 is entering an intrinsically safe controlled environment, and then sets the interval for interrupt to zero. In still another embodiment, it is possible that the device 15 could detect entering an intrinsically safe controlled environment utilizing a sensor. The sensors include, but are not limited to, flammable gas, dust, chemical, vibration, noise, high electric field, temperature, radiation or the like sensors.

At step 366, the sleep agent 360 then powers off any non-communication processor or component that can hibernate until receiving the interrupt to reactivate that non-communication processor or component. After waiting a predetermined interval, the remote clock 59A sends an interrupt to the hibernating non-communication processor and component to power up at step 371. In an alternative embodiment, the remote clock 59A can receive a signal from the modem 57 via a communication link 59B, instructing the remote clock 59A to send an interrupt to the hibernating non-communication processor and components to power up immediately. This signal is originated by the GPS tracking system 100 on the server 11, as shown in FIGS. 1 and 2A. It is in this way that the GPS tracking system 100 on the server 11 can remotely instruct the remote device 15 to awaken from a hibernating state or act as a remote clock 59A from the server 11. After powering up the non-communication processor and components, the sleep agent 360 then synchronizes the system clock (FIG. 2B, item 58) with the remote clock (FIG. 2B, item 59A) at step 372. The sleep agent 360 then exits at step 379.

Any process descriptions or blocks in flow charts should be understood as representing modules, segments, or portions of code which include one or more executable instructions for implementing specific logical functions or steps in the process. Alternate implementations are included within the scope of the preferred embodiment of the present invention in which functions may be executed out of order from that shown or discussed, including substantially concurrently or in reverse order, depending on the functionality involved, as would be understood by those reasonably skilled in the art of the present invention.

It will be apparent to those skilled in the art that many modifications and variations may be made to embodiments of the present invention, as set forth above, without departing substantially from the principles of the present invention. All such modifications and variations are intended to be included herein within the scope of the present invention, as defined in the claims that follow.

What is claimed is:

1. A method for extending the battery life of a mobile device, comprising the steps of:
determining if at least one component on the mobile device can be placed in a hibernation state for a predetermined time;
setting a remote clock to a current time;
powering off the at least one component on the mobile device that can be placed in the hibernation state;
waiting a predetermined interval selected by a user, wherein the time interval can be selected from a factory preset or an environmental setting;
re-activating the at least one component on the mobile device that was placed in the hibernation state; and
synchronizing a system clock with the remote clock.

2. The method of claim 1, wherein the mobile device is a GPS tracking device.

3. The method of claim 2, wherein the step of powering off of the at least one component is performed after determining that the GPS tracking device is unable to obtain a GPS position for the GPS tracking device.

4. The method of claim 2, wherein the step of powering off of the at least one component is performed after determining that the GPS tracking device is unable to establish a communication link to transmit GPS position data.

5. The method of claim 1, wherein the mobile device is a smart phone.

6. The method of claim 5, wherein the communication device is a wireless telephone.

7. The method of claim 1, wherein the mobile device is a mobile computing device.

8. The method of claim 1, wherein the mobile device detects entering an intrinsically safe controlled environment, and then sets the predetermined interval to zero.

9. A system that provides for extending the battery life of a mobile device, comprising:
a priority determination module that determines if at least one component on the mobile device can be placed in a hibernation state for a predetermined time selected by a user, wherein the time interval can be selected from a factory preset or an environmental setting;
a remote clock that is set to a current time of a system clock;
a deactivate module that powers off the at least one component on the mobile device that can be placed in the hibernation state; and
an interrupt routine that reactivates the at least one component on the mobile device that was placed in the hibernation state after waiting a predetermined interval and synchronizes the system clock with the remote clock.

10. The system of claim 9, wherein the mobile device is a GPS tracking device.

11. The system of claim 10, wherein the priority determination module further determines if the GPS tracking device is unable to obtain a GPS position for the GPS tracking device.

12. The system of claim 10, wherein the priority determination module further determines if the GPS tracking device is unable to establish a communication link to transmit GPS position data.

13. The system of claim 9, wherein the mobile device is a smart phone.

14. The system of claim 13, wherein the communication device is a wireless telephone.

15. The system of claim 9, wherein the mobile device is a mobile computing device.

16. The system of claim 9, wherein the mobile device further includes;
an environment detection module that detects entering an intrinsically safe controlled environment, and then sets the predetermined interval to zero.

17. A computer program product for extending the battery life of a mobile device, the computer program product comprising:
a tangible storage medium readable by the mobile device and storing instructions for execution by the mobile device for performing a method comprising:
determining if at least one component on the mobile device can be placed in a hibernation state for a predetermined time;
setting a remote clock to a current time;
powering off the at least one component on the mobile device that can be placed in the hibernation state;
waiting a predetermined interval selected by a user, wherein the predetermined time can be selected from a factory preset or an environmental setting;
re-activating the at least one component on the mobile device that was placed in the hibernation state; and
synchronizing a system clock with the remote clock.

18. The computer program product of claim 17, wherein the mobile device is a GPS tracking device, and wherein the powering off of the at least one component is performed after determining that the GPS tracking device is unable to obtain a GPS position for the GPS tracking device.

19. The computer program product of claim 17, wherein the mobile device is a GPS tracking device, and wherein the step of powering off of the at least one component is performed after determining that the GPS tracking device is unable to establish a communication link to transmit GPS position data.

20. The computer program product of claim 17, wherein the mobile device is a smart phone.

21. The computer program product of claim 17, wherein the mobile device is a mobile computing device.

22. The computer program product of claim 17, wherein the mobile device detects entering an intrinsically safe controlled environment, and then sets the predetermined interval to zero.
